(19) United States
(12) Patent Application Publication
(10) Pub. No.: US 2024/0283605 A1
(43) Pub. Date: Aug. 22, 2024

(54) METHOD AND APPARATUS FOR SRS RECONFIGURATION FOR SUPPORTING POSITIONING SERVICE OF TERMINAL IN WIRELESS COMMUNICATION SYSTEM

(71) Applicant: Samsung Electronics Co., Ltd., Suwon-si (KR)

(72) Inventors: Beomsik BAE, Suwon-si (KR); Taeseop LEE, Suwon-si (KR)

(21) Appl. No.: 18/441,196

(22) Filed: Feb. 14, 2024

(30) Foreign Application Priority Data
Feb. 16, 2023 (KR) 10-2023-0020925

(51) Int. Cl. H04L 5/00; H04W 64/00; H04W 76/20

(52) U.S. Cl. CPC H04L 5/0051; H04L 5/0053; H04W 64/00; H04W 76/20

(57) ABSTRACT

The disclosure relates to a 5G or 6G communication system for supporting higher data transmission rates. A method performed by a first base station (BS) in a wireless communication system is provided. The method includes transmitting, to a second base station (BS), a retrieve user equipment (UE) context request message for sounding reference signal (SRS) configuration, and receiving requested sounding reference signal (SRS) transmission characteristics for the SRS configuration.

### CROSS-REFERENCE TO RELATED APPLICATION(S)

This application is based on and claims priority under 35 U.S.C. § 119(a) of a Korean patent application number 10-2023-0020925, filed on Feb. 16, 2023, in the Korean Intellectual Property Office, the disclosure of which is incorporated by reference herein its entirety.

### BACKGROUND

### 1. Field

The disclosure relates to a wireless communication system. More particularly, the disclosure relates to a method and an apparatus for supporting a positioning service while a user equipment (UE) is in a radio resource control (RRC) INACTIVE state in the wireless communication system.

### 2. Description of Related Art

Fifth-generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth-generation (6G) mobile communication technologies (referred to as Beyond 5G systems (5GSs)) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, Layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing services in a mobile communication system.

Additional aspects will be set forth in part in the description which follows and, in part, will be apparent from the description, or may be learned by practice of the presented embodiments.

In accordance with an aspect of the disclosure, a method of processing a control signal in a wireless communication system is provided. The method includes receiving a first control signal transmitted from a base station, processing the received first control signal, and transmitting a second control signal generated based on the processing to a base station.

In accordance with another aspect of the disclosure, a method performed by a first base station (BS) in a wireless communication system is provided. The method includes transmitting, to a second base station (BS), a retrieve user equipment (UE) context request message for sounding reference signal (SRS) configuration, and receiving requested sounding reference signal (SRS) transmission characteristics for the SRS configuration.

In accordance with another aspect of the disclosure, a method performed by a second base station (BS) in a wireless communication system is provided. The method includes receiving, from a first base station (BS), a retrieve user equipment (UE) context request message for sounding reference signal (SRS) configuration, and transmitting information for the SRS configuration.

In accordance with another aspect of the disclosure, a first base station (BS) in a wireless communication system is provided. The first BS includes a transceiver, memory storing one or more computer programs, and one or more processors communicatively coupled with the transceiver and the memory, wherein the one or more computer programs include computer-executable instructions, that, when executed by the one or more processors, cause the first BS to transmit, to a second base station (BS), a retrieve user equipment (UE) context request message for sounding reference signal (SRS) configuration, and receive requested sounding reference signal (SRS) transmission characteristics for the SRS configuration.

In accordance with another aspect of the disclosure, a second base station (BS) in a wireless communication system is provided. The second BS includes a transceiver, memory storing one or more computer programs, and one or more processors communicatively coupled with the transceiver and the memory, wherein the one or more computer programs include computer-executable instructions, that, when executed by the one or more processors, cause the second BS to receive, from a first base station (BS), a retrieve user equipment (UE) context request message for sounding reference signal (SRS) configuration, and transmit information for the SRS configuration.

In accordance with another aspect of the disclosure, one or more non-transitory computer-readable storage media storing one or more computer programs including computer-executable instructions that, when executed by one or more processors of a first base station (BS), cause the first BS to perform operations are provided. The operations include transmitting, to a second base station (BS), a retrieve user equipment (UE) context request message for sounding reference signal (SRS) configuration, and receiving requested sounding reference signal (SRS) transmission characteristics for the SRS configuration.

The disclosed embodiment provides an apparatus and a method capable of effectively providing services in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the structure of a mobile communication system (or a wireless communication system) for providing a positioning service according to an embodiment of the disclosure;

FIG. 2 is a signal flow illustrating reconfiguration of uplink sounding reference signal (SRS) configuration information transmitted by a UE for positioning service while the UE is in an RRC INACTIVE state according to an embodiment of the disclosure;

FIG. 3 is a signal flow illustrating reconfiguration of uplink sounding reference signal (SRS) configuration information transmitted by a UE for positioning service while the UE is in an RRC INACTIVE state according to an embodiment of the disclosure;

FIG. 4A illustrates an operation sequence of a base station according to an embodiment of the disclosure;

FIG. 4B illustrates an operation sequence of a base station according to an embodiment of the disclosure;

FIG. 5A illustrates an Xn retrieve UE context request message and an information element (IE) included in the Xn retrieve UE context request message according to an embodiment of the disclosure;

FIG. 5B illustrates an Xn retrieve UE context request message and an information element (IE) included in the Xn retrieve UE context request message according to an embodiment of the disclosure;

FIG. 6A illustrates an Xn retrieve UE context response message and an information element (IE) included in the Xn retrieve UE context response message according to an embodiment of the disclosure;

FIG. 6B illustrates an Xn retrieve UE context response message and an information element (IE) included in the Xn retrieve UE context response message according to an embodiment of the disclosure;

FIG. 6C illustrates an Xn retrieve UE context response message and an information element (IE) included in the Xn retrieve UE context response message according to an embodiment of the disclosure;

FIG. 7 illustrates an NR positioning protocol A (NRPPa) positioning information update message according to an embodiment of the disclosure;

FIG. 8 illustrates an Xn partial UE context transfer message and an information element (IE) included in the Xn partial UE context transfer message according to an embodiment of the disclosure;

FIG. 9A illustrates an Xn partial UE context transfer acknowledge message and an information element (IE) included in the Xn partial UE context transfer acknowledge message according to an embodiment of the disclosure;

FIG. 9B illustrates an Xn partial UE context transfer acknowledge message and an information element (IE) included in the Xn partial UE context transfer acknowledge message according to an embodiment of the disclosure;

FIG. 10A illustrates an Xn UE positioning information request message, an Xn UE positioning information response message, and an information element (IE) included in the message, to support an Xn UE positioning information request procedure according to an embodiment of the disclosure;

FIG. 10B illustrates an Xn UE positioning information request message, an Xn UE positioning information response message, and an information element (IE) included in the message, to support an Xn UE positioning information request procedure according to an embodiment of the disclosure;

FIG. 11 is a signal flow illustrating reconfiguration of uplink sounding reference signal (SRS) configuration information transmitted by a UE for positioning service while the UE is in an RRC INACTIVE state according to an embodiment of the disclosure;

FIG. 12 illustrates an operation sequence of a base station according to an embodiment of the disclosure;

FIG. 13 is a signal flow illustrating reconfiguration of uplink sounding reference signal (SRS) configuration information transmitted by a UE for positioning service while the UE is in an RRC INACTIVE state according to an embodiment of the disclosure;

FIG. 14 illustrates an operation sequence of a base station according to an embodiment of the disclosure;

FIG. 15A illustrates an NRPPa positioning information update message, an NRPPa positioning information update required message, and an information element (IE) included in the NRPPa message according to an embodiment of the disclosure;

FIG. 15B illustrates an NRPPa positioning information update message, an NRPPa positioning information update required message, and an information element (IE) included in the NRPPa message according to an embodiment of the disclosure;

FIG. 16 illustrates an NRPPa positioning information request message and an information element (IE) included in the NRPPa positioning information request message according to an embodiment of the disclosure;

FIG. 17 is a signal flow illustrating reconfiguration of uplink sounding reference signal (SRS) configuration information transmitted by a UE for positioning service while the UE is in an RRC INACTIVE state according to an embodiment of the disclosure;

FIG. 18 is a signal flow illustrating reconfiguration of uplink sounding reference signal (SRS) configuration information transmitted by a UE for positioning service while the UE is in an RRC INACTIVE state according to an embodiment of the disclosure;

FIG. 19 illustrates an operation sequence of a base station according to an embodiment of the disclosure;

FIG. 20 illustrates an operation sequence of a UE according to an embodiment of the disclosure;

FIG. 21A illustrates a long term evolution (LTE) positioning protocol (LPP) message and an information element (IE) included in the LPP message according to an embodiment of the disclosure;

FIG. 21B illustrates an LTE positioning protocol (LPP) message and an information element (IE) included in the LPP message according to an embodiment of the disclosure;

FIG. 21C illustrates an LTE positioning protocol (LPP) message and an information element (IE) included in the LPP message according to an embodiment of the disclosure;

FIG. 22 is a block diagram showing the internal structure of a base station according to an embodiment of the disclosure; and

FIG. 23 is a block diagram showing a configuration of a terminal according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to New Radio (NR) as a radio access network and Packet Core (5G system, 5G Core Network, or next generation core (NG Core)) as a core network, which are specified in the 5G mobile communication standards defined by the 3rd generation partnership project (3GPP) that is a mobile communication standardization group, but based on determinations by those skilled in the art, the main idea of the disclosure may be applied to other communication systems having similar backgrounds or channel types through some modifications without significantly departing from the scope of the disclosure.

In the following description, some of terms and names defined in the 3GPP standards (standards for 5G, NR, LTE, or similar systems) will be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, according to some embodiments, the “unit” may include one or more processors.

In the following description, the disclosure will be described using terms and names defined in the 5GS and NR standards, which are the latest standards specified by the 3rd generation partnership project (3GPP) group among the existing communication standards, for the convenience of description. However, the disclosure is not limited by these terms and names, and may be applied in the same way to systems that conform other standards. In particular, the disclosure may be applied to the 3GPP 5GS/NR (5th generation mobile communication standards).

The disclosed embodiment relates to providing a positioning service for a user equipment (UE) in a mobile communication system and, more specifically, may provide a method of, when the positioning service is provided using an uplink sounding reference signal (SRS) transmitted by the UE even when the UE is in an RRC INACTIVE state, requesting an SRS reconfiguration from a base station in which the UE is located and then receiving SRS configuration information from the base station again, wherein the SRS reconfiguration request occurs when the UE determines that reconfiguration of uplink SRS configuration information received while the UE transitions to the RRC INACTIVE state SRS is required for a reason such that a cell in which the UE is located changes due to the UE moving from the RRC INACTIVE state, or the UE leaves a validity area established with the uplink sounding reference signal (SRS) configuration information.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

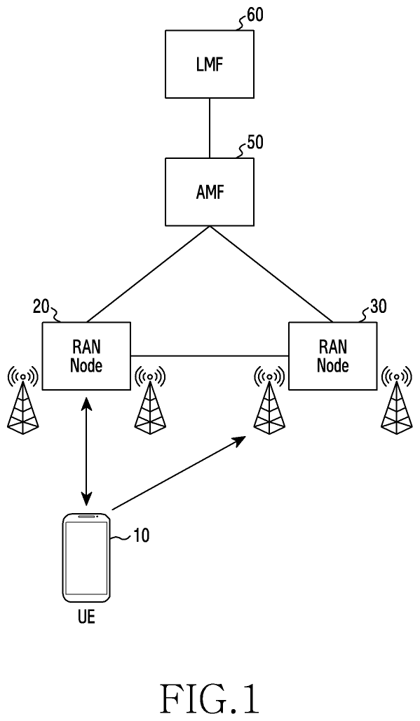

FIG. 1 illustrates the structure of a mobile communication system (or a wireless communication system) for providing a positioning service according to an embodiment of the disclosure.

Referring to FIG. 1, radio access network (RAN) nodes 20 and 30 specified in a communication system structure for providing a positioning service may be mobile communication base stations connected to a core network (CN), such as a 5G core network (5GC), and may be mobile communication base stations directly connected to an access and mobility management function (AMF) 50 included in the 5GC. For example, the RAN node 30 may be an NR gNB or the like. The UE 10 may communicate with the RAN node 20 of a cell in which the UE 10 is located. Further, the neighboring RAN nodes 30 of the cell in which the UE 10 is located may receive an uplink signal (e.g., an uplink SRS signal) transmitted by the UE 10 for positioning, and the uplink signal (e.g., the uplink SRS signal) transmitted by the UE 10 for positioning may be utilized as information for positioning services. According to an embodiment of the disclosure, the positioning service may refer to a service for calculating the location of a UE. The RAN nodes 20 and 30 may use a base station-to-base station interface (e.g., an Xn interface) to perform communication between the RAN nodes. Further, the RAN nodes 20 and 30 may be separately organized into a plurality of network devices (e.g., including at least one of a central unit (CU), a distributed unit (DU), and a remote unit (RU)).

A location management function (LMF) 60 is a function (or an entity) of a core network for providing a positioning service for calculation the location of the UE, and may be connected to the AMF 50 and communicate with the RAN nodes 20 and 30 and the UE 10 through the AMF to provide the positioning service. The RAN nodes 20 and 30 and the AMF 50 of the core network may communicate using an interface (e.g., an NG interface) between the RAN nodes and the core network. The AMF 50 may use a positioning-related protocol (e.g., NR positioning protocol A (NRPPa)) when communicating with the location management function (LMF) 60 and the RAN nodes 20 and 30, and positioning-related protocol messages (e.g., NRPPa messages) may be included in messages of an interface (e.g., an NG interface) used for connection between the RAN nodes 20 and 30 and the core network.

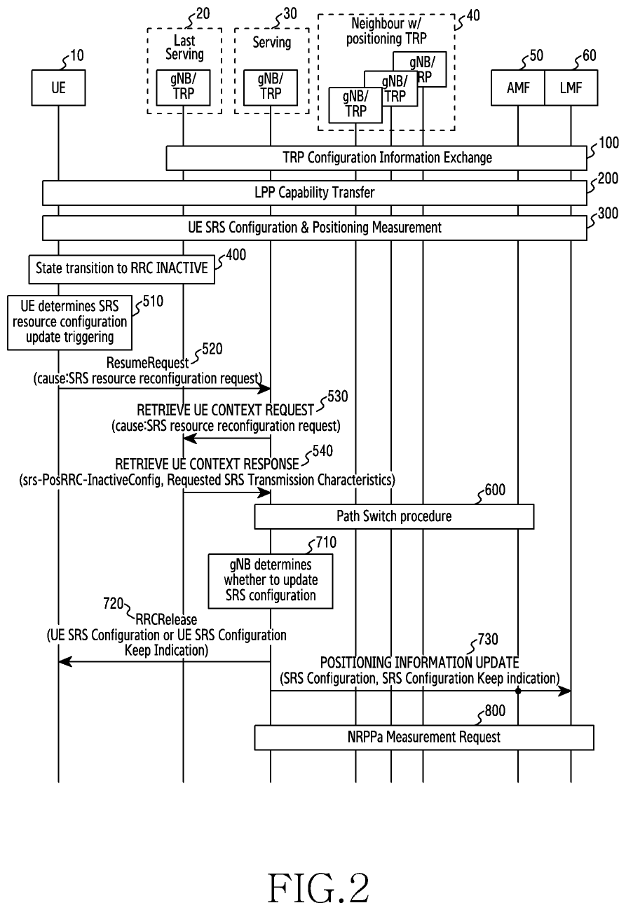

FIG. 2 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 2, when the positioning service is provided using an uplink sounding reference signal (SRS) transmitted by the UE in the RRC INACTIVE state, in case that the UE determines that reconfiguration of the SRS is required for a reason such that a cell in which the UE is located changes due to the UE moving from the RRC INACTIVE state, or the UE leaves a validity area established with the uplink sounding reference signal (SRS) configuration information, a signal flow describing a method and signal procedure for requesting an SRS reconfiguration from a base station where the UE is located and then receiving the SRS configuration information again from the base station is shown. According to an embodiment of the disclosure, the validity area may be a region in which the UE is able to continuously use the received SRS configuration information even when the cell in which the UE is located changes.

In operation 100, the LMF 60 may perform a procedure of receiving information about a transmission and reception point (TRP) for positioning service from base stations 20 and 30, and 40 (e.g., NR gNB or LTE eNB), and messages required for the procedure of receiving information about the TRP for the positioning service may be transmitted and/or received via the AMF 50.

In operation 200, the LMF 60 may request positioning capability information of the UE 10 via an LTE positioning protocol (LPP) capability transfer procedure with the UE 10, and may receive positioning capability information from the UE 10.

In operation 300, while the UE 10 is connected to the last serving base station 20, a procedure related to an uplink SRS transmission configuration may be performed, and in the procedure related to the uplink SRS transmission configuration, a positioning monitoring procedure related to measuring the uplink SRS may be performed.

In operation 400, the last serving base station 20 may determine to transition the UE 10 to the RRC INACTIVE state, and after transitioning to the RRC INACTIVE state, the UE 10 may move to a cell of the serving base station 30.

In operation 510, the UE may determine, based on system information transmitted by the serving base station, based on signals received by the base station, or based on internal operations, that the uplink SRS transmission configuration information received by the UE 10 while transitioning to the RRC INACTIVE state previously is invalid. In this case, the UE 10 may initiate a procedure for requesting an SRS reconfiguration. In case of the following criteria, a UE may determine that SRS reconfiguration is necessary because SRS transmission configurations are invalid.
A case in which the UE selects a cell other than a cell belonging to a validity area of the currently stored or used SRS configuration information (Upon cell re-selection to a cell that does not belong to the validity area of the currently used SRS configuration).
A case in which the UE fails to measure a downlink reference signal (RS) for spatial information included in the SRS configuration information (Upon failure of measurement on DL RS for spatial information configured for SRS).
A case in which the UE fails to measure a downlink reference signal (RS) for pathloss information included in the SRS configuration information (Upon failure of measurement on DL RS for pathloss information configured for SRS).
A case in which the UE detects that a timing advanced (TA) value for SRS transmission becomes invalid (Upon detection of invalid TA for SRS Tx (i.e., expiry of inactivePosSRS-TimeAlignmentTimer or reference signal received power (RSRP) change over inactivePosSRS-RSRP-ChangeThreshold)).

When the UE 10 initiates the procedure for requesting SRS reconfiguration, the UE 10 may transmit an RRC ResumeRequest message to the serving base station 30 (cell of the base station) currently selected by the UE 10 in operation 520. The RRC ResumeRequest message transmitted by the UE 10 includes SRS resource reconfiguration request information (SRS resource reconfiguration request), and the SRS resource reconfiguration request information may use cause information included in the RRC ResumeRequest message, or may use separate indicator information. An example of the composition of an RRC ResumeRequest message is shown below. Of course, it is not limited to this example.

| | |
|---|---|
| RRCResumeRequest-IEs ::= | SEQUENCE { |
| resumeIdentity | ShortI-RNTI-Value, |
| resumeMAC-I | BIT STRING (SIZE (16)), |
| resumeCause | ResumeCause, |
| spare | BIT STRING (SIZE (1)) |

}

| | |
|---|---|
| ResumeCause ::= | ENUMERATED {emergency, |

highPriorityAccess, mt-Access, mo-Signalling,

mo-Data, mo-VoiceCall, mo-VideoCall,

mo-SMS, rna-Update, mps-PriorityAccess,

mcs-PriorityAccess,

srs-ResourceReconfigurationRequest, spare2, spare3, spare4, spare5 }

When a value of resumeCause in the RRC ResumeRequest message is configured as ‘SRS-ResourceReconfigurationRequest’, the base station may identify that the UE has initiated the corresponding RRC Resume procedure for SRS reconfiguration in the RRC INACTIVE state.

Upon receiving the RRC ResumeRequest message from the UE 10, the serving base station 30 may transmit an Xn retrieve UE context request message requesting UE context information to the last serving base station 20 to which the UE 10 has previously been connected and which has stored UE context information, in operation 530. The Xn retrieve UE context request message may include information (SRS resource reconfiguration request) indicating that the request for UE context has been caused by an SRS resource reconfiguration request, and the SRS reconfiguration request information may use cause information included in the Xn retrieve UE context request message, or may use separate indicator information.

In operation 540, the last serving base station 20 may transmit an Xn retrieve UE context response message including UE context information to the serving base station 30. The Xn retrieve UE context response message may include requested SRS transmission characteristic information required for SRS configuration. The last serving base station 20 may store the requested SRS transmission characteristic information received from the LMF 60 during operation 300, and may transmit the stored requested SRS transmission characteristic information to the serving base station 30 in operation 540. In operation 540, the last serving base station 20 may transmit the Xn retrieve UE context response message by including therein the SRS configuration (srs-PosRRC-InactiveConfig) information currently configured for the UE.

In operation 600, the serving base station 30 may perform a path switch procedure associated with cell change in the RRC INACTIVE state.

In operation 710, the serving base station 30 may determine SRS configuration information to be configured for the UE 10 based on the information, which has been received from the last serving base station 20 in operation 540. In addition, the serving base station may determine the validity area information of the SRS configuration. The validity area information of the SRS configuration may include a cell list, a RAN area ID list, or a tracking area ID list.

In operation 720, the serving base station 30 may transmit, to the UE 10, an RRC message including the SRS configuration information, determination of which has been made in operation 710, for example, an RRCRelease message. The RRC message transmitted to the UE 10 in operation 720 may include at least one of SRS configuration information or SRS configuration keep indication of the UE. Further, the RRC message may include the validity area information of the SRS configuration.

In operation 730, the serving base station 30 may transmit an NR positioning protocol A (NRPPa) message that includes the SRS configuration information, determination of which has been made in operation 710, for example, an NRPPa positioning information update message, to the LMF 60 via the AMF 50. The NRPPa message transmitted to the LMF 60 in operation 730 may include at least one of SRS configuration information or SRS configuration keep indication of the UE. Further, the NRPPa message may also include validity area information for the SRS configuration.

In operation 800, the LMF 60 may determine at least one of the base station, the cell, or the TRP to monitor (measure) the uplink SRS transmitted by the UE, and may request monitoring the uplink SRS of the UE from each base station via the AMF 50 by using the NRPPa measurement request procedure. Further, the LMF 60 may receive the results of measuring the uplink SRS from each base station, and may calculate the location information of the UE based on the received information.

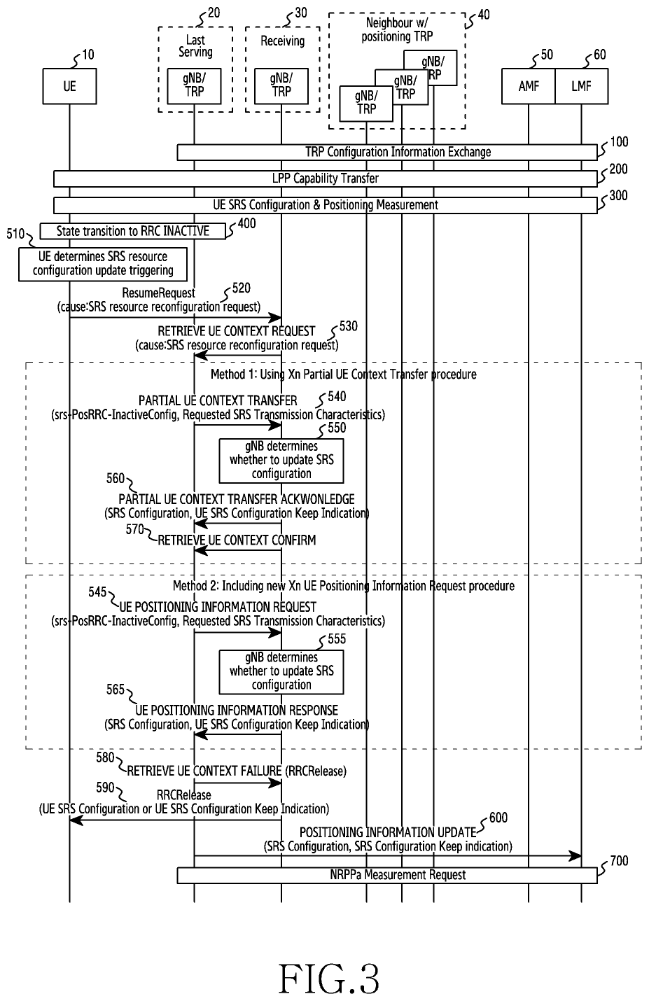

FIG. 3 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 3, the signal flow procedure from operation 100 to operation 520 in FIG. 3 corresponds to the signal flow procedure from operation 100 to operation 520 included in FIG. 2, and thus a detailed description will be omitted.

Upon receiving the RRC ResumeRequest message from the UE 10, the receiving base station 30 may transmit an Xn retrieve UE context request message requesting UE context information to the last serving base station 20, to which the UE 10 has been previously connected and which has stored UE context information, in operation 530. The Xn retrieve UE context request message may include information (SRS resource reconfiguration request) indicating that the request for UE context has been caused by an SRS reconfiguration request, and the SRS reconfiguration request information may use cause information included in the Xn retrieve UE context request message, or may use separate indicator information.

In operation 530, upon receiving, from the receiving base station 30, the Xn retrieve UE context request message including information requesting the UE context information and information (SRS resource reconfiguration request) indicating that the request for the UE context has been caused by the SRS reconfiguration request, the last serving base station 20 may determine to continue to store the context information of the UE 10 without transferring the UE context information to the receiving base station 30.

In operation 540 of FIG. 3, the last serving base station 20 may transmit, to the receiving base station 30, an Xn message that transfers only partial UE context information of the UE, for example, an Xn partial UE context transfer message. The Xn partial UE context transfer message may include requested SRS transmission characteristic information required for SRS configuration. The last serving base station 20 may store the requested SRS transmission characteristic information received from the LMF 60 during operation 300 and may transmit the stored requested SRS transmission characteristic information to the receiving base station 30 in operation 540. In operation 540, the last serving base station 20 may transmit the Xn partial UE context transfer message by including therein the SRS configuration (srs-PosRRC-InactiveConfig) information that is currently configured for the UE.

In operation 550, the receiving base station 30 may determine SRS configuration information to be configured for the UE 10 based on the information, which has been received from the last serving base station in operation 540. In addition, the receiving station 30 may determine validity area information of the SRS configuration. The validity area information of the SRS configuration may include a cell list, a RAN area ID list, or a tracking area ID list.

In operation 560, the receiving base station 30 may transmit the Xn retrieve UE context request message to the last serving base station 20. The Xn retrieve UE context request message may include at least one of the SRS configuration information or SRS configuration keep indication of the UE based on the SRS configuration information, determination of which has been made in operation 550. In addition, validity area information of the SRS configuration may be included.

In operation 570, the receiving base station 30 may transmit an Xn retrieve UE context confirmation message to the last serving base station 20.

The signal procedure from operation 540 to operation 550, operation 560, and operation 570 of FIG. 3 may be supported by the signal procedure method of operation 545, operation 555, and operation 565. In operation 545, the last serving base station 20 may transmit, to the receiving base station 30, an Xn message for transferring information related to the positioning of the UE, for example, an Xn UE positioning information request message. The Xn UE positioning information request message may include requested SRS transmission characteristic information required for SRS configuration. The last serving base station 20 may store the requested SRS transmission characteristic information received from the LMF 60 during operation 300, and may transmit the stored requested SRS transmission characteristic information to the receiving base station 30 in operation 545. In operation 545, the last serving base station 20 may transmit the Xn positioning information response message by including therein the SRS configuration (srs-PosRRC-InactiveConfig) information that is currently configured for the UE. In operation 555, the receiving base station 30 may determine the SRS configuration information to be configured for the UE 10 based on the information received from the last serving base station in operation 545. Further, the receiving base station 30 may determine the validity area information of the SRS configuration. The validity area information of the SRS configuration may include a cell list, a RAN area ID list, or a tracking area ID list. In operation 565, the receiving base station 30 may transmit an Xn UE positioning information response message to the last serving base station 20. The Xn UE positioning information response message may include at least one of the SRS configuration information or SRS configuration keep indication of the UE based on the SRS configuration information, determination of which has been made in operation 550. The Xn UE positioning information response message may also include validity area information of the SRS configuration.

After operation 570 or operation 565 of FIG. 3, the last serving base station 20 may generate an RRCRelease message to be transmitted to the UE, and may transmit an Xn retrieve UE context failure message including the RRCRelease message to be transmitted to the UE to the receiving base station 30 in operation 580. The RRCRelease message to be transmitted to the UE includes information related to the received SRS configuration of the UE having been received from the receiving base station 30 in operation 560 or operation 565, and may include at least one of the SRS configuration information or the SRS configuration keep indication of the UE. The RRCRelease message may also include validity area information of the SRS configuration.

Upon receiving the RRCRelease message received from the last serving base station 20 in operation 580, the receiving base station 30 may transmit the received RRCRelease message to the UE 10 in operation 590. The RRC message transmitted to the UE 10 in operation 590 may include at least one of SRS configuration information or SRS configuration keep indication of the UE. The RRC message may also include the validity area information of the SRS configuration.

In operation 600, the last serving base station 20 may transmit an NRPPa message that includes the SRS configuration information having been received from the receiving base station 30 in operation 560 or operation 565, for example, an NRPPa positioning information update message, to the LMF 60 via the AMF 50. The NRPPa positioning information update message may include at least one of SRS configuration information or SRS configuration keep indication of the UE. Further, the NRPPa position information update message may also include validity area information for the SRS configuration.

In operation 700, the LMF 60 may determine at least one of the base station, the cell, or the TRP to monitor (measure) the uplink SRS transmitted by the UE, and may request monitoring the uplink SRS of the UE from each base station via the AMF 50 by using the NRPPa measurement request procedure. Further, the LMF 60 may receive the results of measuring the uplink SRS from each base station, and may calculate the location information of the UE based on the received information.

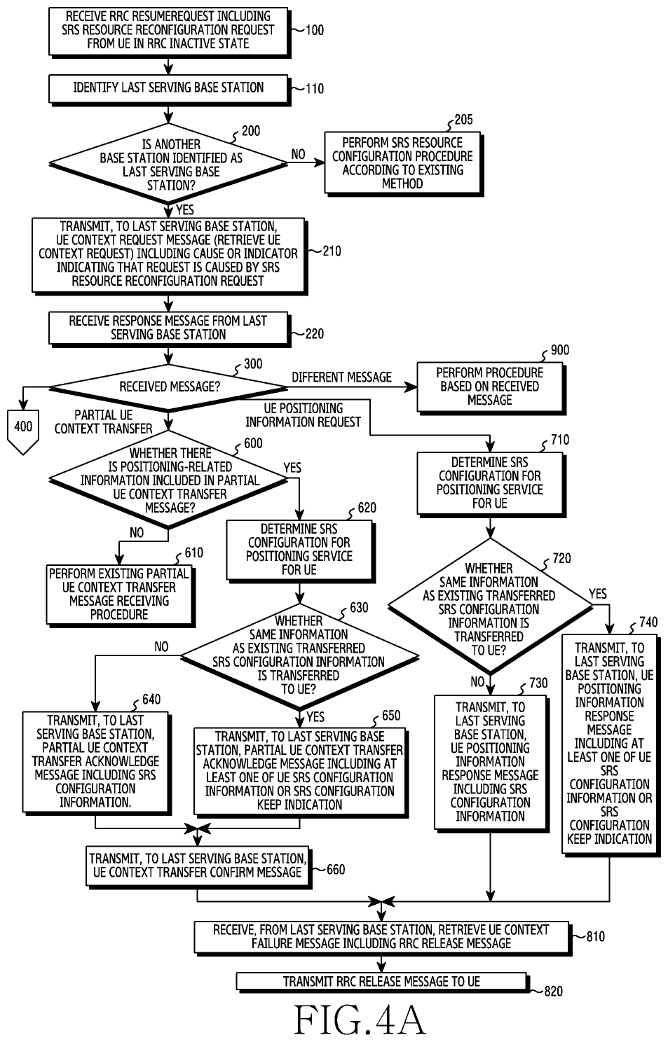

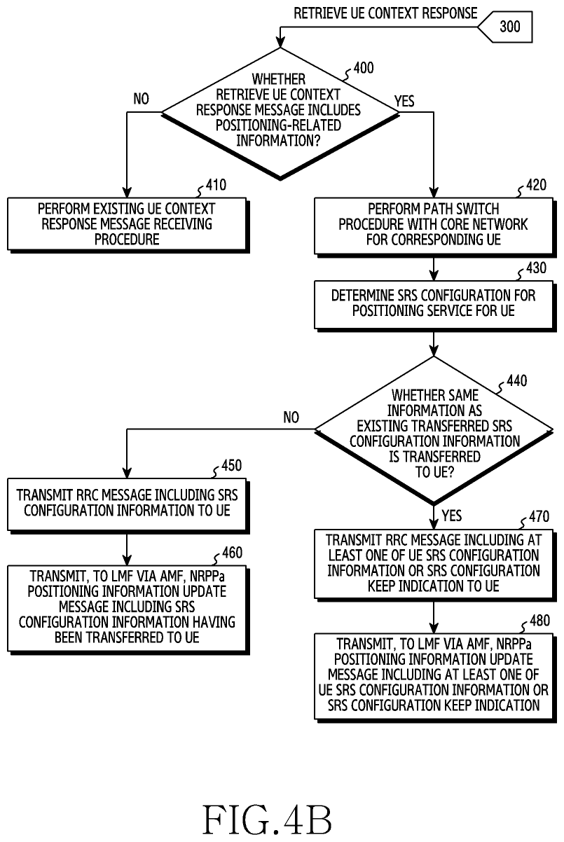

FIG. 4A illustrates an operation sequence of a base station according to an embodiment of the disclosure, and FIG. 4B illustrates an operation sequence of a base station according to an embodiment of the disclosure. With respect to the operation sequence of the base station included in FIGS. 4A and 4B, the base station may be unable to support some of procedures of the base station included in FIGS. 4A and 4B and some operations may be omitted, depending on functions supported by the base station.

Referring to FIGS. 4A and 4B, in operation 100, the base station may receive an RRC ResumeRequest message including an SRS resource reconfiguration request from a UE in the RRC INACTIVE state. In operation 110, identification of which base station corresponds to a last serving base station is possible, based on the RRC ResumeRequest message transmitted by a UE. In operation 200, when the context of the UE that has transmitted the ResumeRequest message is already stored (the base station that has received the ResumeRequest message corresponds to the last serving base station), the SRS resource configuration procedure may be performed, if necessary, along with the existing RRC ResumeRequest message processing in operation 205.

In operation 200, when another base station is identified as the last serving base station, a UE context request message, for example, Xn retrieve UE context request message, the message including a cause value indicating that the request is caused by the SRS resource reconfiguration request or separate indication information, may be transmitted to the last serving base station in operation 210. In operation 220, a response message may be received from the last serving base station.

The type of the message, which has been received from the last serving base station in operation 220, may be determined in operation 300, and when the message received from the last serving base station does not correspond to a UE context response message, for example, an Xn retrieve UE context response message, a partial UE context transfer message, for example, an Xn partial UE context transfer message, or a UE positioning information request message, for example, an Xn UE positioning information request message, the predetermined procedure may be performed according to the type of received message in operation 900.

As a result of the determination in operation 300, when the message corresponds to a UE context response message, for example, an Xn retrieve UE context response message, whether the UE context response message, for example, an Xn retrieve UE context response message includes positioning-related information of the UE may be determined in operation 400. As a result of the determination in operation 400, when there is no positioning-related information included in the UE context response message, a processing procedure after receiving the existing UE context response message may be performed in operation 410.

As a result of the determination in operation 400, when the positioning-related information is included the UE context response message, a path switch procedure with a core network for the UE may be performed in operation 420. Further, in operation 430, the base station may determine the SRS configuration of the UE based on the UE positioning-related information received from the last serving base station. In operation 430, the base station may also determine the validity area according to the SRS configuration information of the UE. In operation 440, the base station may determine whether the SRS configuration information of the UE, which has been determined in operation 430, is the same as the SRS configuration information currently configured for the UE. The determination performed by the base station in operation 440 may be based on a comparison with the SRS configuration information, which has been determined in operation 430, when the UE positioning-related information received from the last serving base station includes the current SRS configuration information of the UE. As a result of the determination in operation 440, when SRS configuration information different from the current SRS configuration information of the UE is determined to be used, an RRC message (e.g., an RRCRelease message) including the SRS configuration information may be transmitted to the UE in operation 450. Of course, the base station may transmit the determined SRS configuration information (or a message including the SRS configuration information) without comparing whether the determined SRS configuration information is the same as the current UE SRS configuration information.

The RRC message (e.g., the RRCRelease message) transmitted to the UE in operation 450 may also include the validity area information of the SRS configuration information. In operation 460, the base station may transmit an NRPPa message (e.g., an NRPPa positioning information update message) including the SRS configuration information transferred to the UE via the AMF to the LMF. The NRPPa message (e.g., the NRPPa positioning information update message) transmitted in operation 460 may also include the validity area information of the SRS configuration information.

As a result of the determination in operation 440, when the same SRS configuration information as the current SRS configuration information of the UE is been determined to be used, an RRC message (e.g., an RRCRelease message) including at least one of the SRS configuration information or SRS configuration keep indication may be transmitted to the UE in operation 470. The RRC message (e.g., RRCRelease message) transmitted to the UE in operation 470 may also include the validity area information of the SRS configuration information. In operation 480, the base station may transmit, to the LMF via the AMF, an NRPPa message (e.g., an NRPPa positioning information update message) including at least one of the SRS configuration information or the SRS configuration keep indication having been transmitted to the UE. The NRPPa message (e.g., the NRPPa positioning information update message) transmitted in operation 460 may also include the validity area information of the SRS configuration information.

As a result of the determination in operation 300, when the message is a partial UE context transfer message (e.g., an Xn partial UE context transfer message), whether the partial UE context transfer message (e.g., an Xn partial UE context transfer message) includes positioning-related information of the UE may be determined in operation 600. As a result of the determination in operation 600, when there is no positioning-related information included in the partial UE context transfer message, a processing procedure after receiving the existing partial UE context transfer message may be performed in operation 610.

As a result of the determination in operation 600, when the positioning-related information is included in the partial UE context transfer message, the base station may determine the SRS configuration of the UE based on the UE positioning-related information received from the last serving base station in operation 620. In operation 620, the base station may also determine the validity area according to the SRS configuration information of the UE. In operation 630, the base station may determine that the SRS configuration information of the UE, which has been determined in operation 620, is the same as the SRS configuration information currently configured for the UE. The determination performed by the base station in operation 630 may be based on a comparison with the SRS configuration information, which has been determined in operation 620, when the UE positioning-related information received from the last serving base station includes the current SRS configuration information of the UE. As a result of the determination in operation 630, when SRS configuration information different from the current SRS configuration information of the UE is determined to be used, a partial UE context transfer acknowledgment message (e.g., Xn partial UE context transfer acknowledge message) including the SRS configuration information of the UE may be transmitted to the last serving base station in operation 640. Of course, the base station may transmit the determined SRS configuration information (or a message including the SRS configuration information) without comparing whether the determined SRS configuration information is the same as the current UE SRS configuration information.

In operation 640, the partial UE context transfer acknowledgment message (e.g., Xn partial UE context transfer acknowledge message) transmitted to the last serving base station may also include the validity area information of the SRS configuration information. As a result of the determination in operation 630, when the same SRS configuration information as the current UE SRS configuration information is determined to be used, a partial UE context transfer acknowledgment message (e.g., an Xn partial UE context transfer acknowledge message) including at least one of the SRS configuration information or SRS configuration keep indication of the UE may be transferred to the last serving base station in operation 650. The partial UE context transfer acknowledgment message (e.g., Xn partial UE context transfer acknowledge message) transmitted to the last serving base station in operation 650 may also include the validity area information of the SRS configuration information.

In operation 660, a UE context transfer confirm message (e.g., an Xn retrieve UE context confirm message) may be transmitted to the last serving base station. Further, in operation 810, an Xn message including an RRCRelease message (e.g., an Xn retrieve UE context failure message) may be received from the last serving base station, and in operation 820, the RRCRelease message received from the last serving base station may be transmitted to the UE.

As a result of the determination in operation 300, when the message is a UE positioning information request message (e.g., an Xn UE positioning information request message), the base station may determine the SRS configuration of the UE, based on the UE positioning-related information from the last serving base station in operation 710. In operation 710, the base station may also determine the validity area according to the SRS configuration information of the UE. In operation 720, the base station may determine whether the SRS configuration information of the UE, which has been determined in operation 710, is the same as the SRS configuration information currently configured for the UE. The determination performed by the base station in operation 720 may be based on a comparison with the SRS configuration information, which has been determined in operation 710, when the UE positioning-related information received from the last serving base station includes the current SRS configuration information of the UE. As a result of the determination in operation 720, when SRS configuration information different from the current SRS configuration information of the UE is determined to be used, a UE positioning information response message (e.g., Xn UE positioning information response message) including the SRS configuration information of the UE may be transmitted to the last serving base station in operation 730. Of course, the base station may transmit the determined SRS configuration information (or a message including the SRS configuration information) without comparing whether the determined SRS configuration information is the same as the current UE SRS configuration information.

In operation 730, the UE positioning information response message (e.g., Xn UE positioning information response message) transmitted to the last serving base station may also include the validity area information of the SRS configuration information. As a result of the determination in operation 720, when the same SRS configuration information as the current UE SRS configuration information is determined to be used, the UE positioning information response message (e.g., Xn UE positioning information response message) including at least one of the SRS configuration information or SRS configuration keep indication of the UE may be transferred to the last serving base station in operation 740. In operation 740, the UE positioning information response message (e.g., Xn UE positioning information response message) transmitted to the last serving base station may also include the validity area information of the SRS configuration information. Further, in operation 810, an Xn message including an RRCRelease message (e.g., an Xn retrieve UE context failure message) may be received from the last serving base station, and in operation 820, the RRCRelease message received from the last serving base station may be transmitted to the UE.

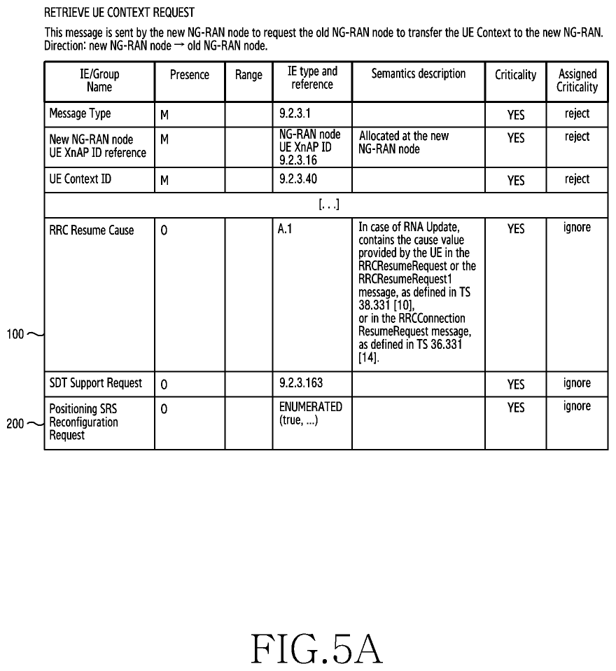

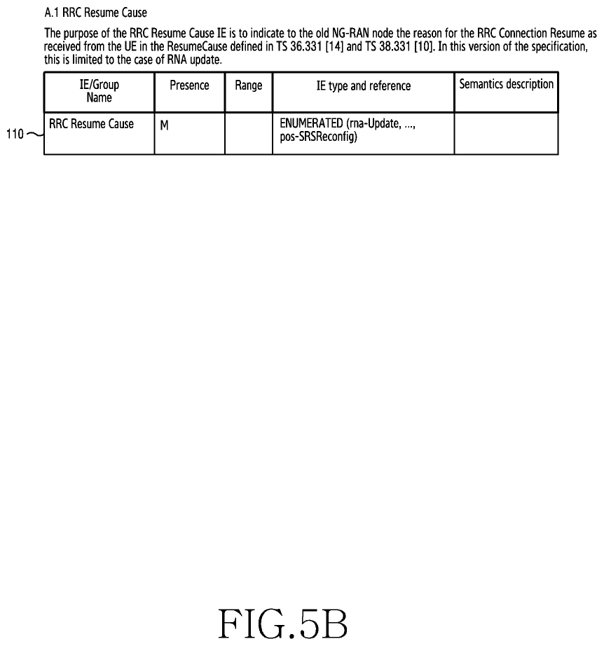

FIG. 5A illustrates an Xn retrieve UE context request message and an information element (IE) included in the Xn retrieve UE context request message according to an embodiment of the disclosure, and FIG. 5B illustrates an Xn retrieve UE context request message and an information element (IE) included in the Xn retrieve UE context request message according to an embodiment of the disclosure.

Referring to FIGS. 5A and 5B, an example of a configuration of an Xn retrieve UE context request message transmitted by a serving base station to a last serving base station and an information element (IE) included in the Xn retrieve UE context request message, which are used in operation 530 of FIG. 2 or operation 530 of FIG. 3, may be described. The IE names included in FIGS. 5A and 5B are illustrative only, and may be used by other names for the same function.

FIG. 5A illustrates an example of an Xn retrieve UE context request message. The Xn retrieve UE context request message may include RRC resume cause information by which the Xn retrieve UE context request procedure is initiated, as indicated in operation 100. FIG. 5B illustrates an example of a configuration of the RRC resume cause IE, wherein, as indicated in operation 110, the RRC resume cause information may use ‘pos-SRSReconfig’ information indicating a request of positioning-support SRS reconfiguration for the disclosure, in addition to ‘rna-update’ information indicating a request to change an existing RAN notification area. Of course, other indicators may be used to indicate the SRS reconfiguration request as described earlier. In addition, the Xn retrieve UE context request message may include a positioning SRS reconfiguration request IE that includes indication information to request a positioning-support SRS reconfiguration, as indicated in operation 200 of FIG. 5A, as an alternative method of requesting a positioning-support SRS reconfiguration.

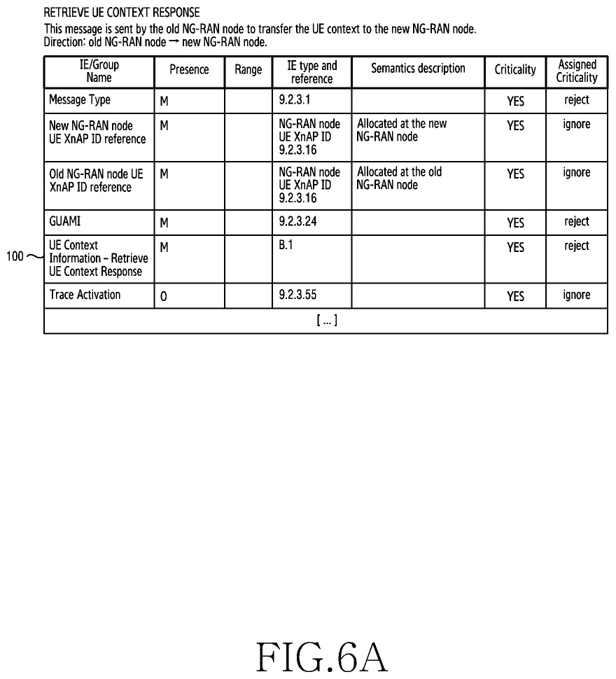

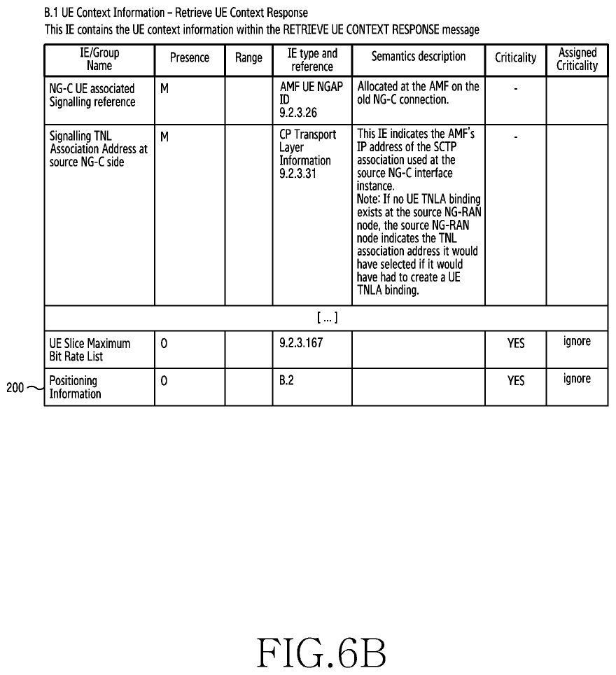

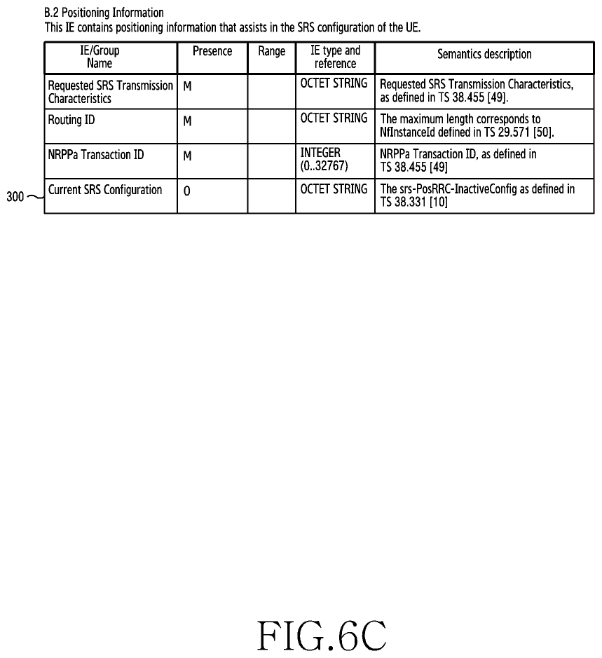

FIG. 6A illustrates an Xn retrieve UE context response message and an information element (IE) included in the Xn retrieve UE context response message according to an embodiment of the disclosure, FIG. 6B illustrates an Xn retrieve UE context response message and an information element (IE) included in the Xn retrieve UE context response message according to an embodiment of the disclosure, and FIG. 6C illustrates an Xn retrieve UE context response message and an information element (IE) included in the Xn retrieve UE context response message according to an embodiment of the disclosure.

Referring to FIGS. 6A to 6C, an example of an Xn retrieve UE context response message transmitted by a last serving base station to a serving base station and an information element (IE) included in the Xn retrieve UE context response message, which are used in operation 540 of FIG. 2, may be illustrated. The IE names included in FIGS. 6A, 6B, and 6C are illustrative only, and may be used by other names for the same function.

FIG. 6A illustrates an example of an Xn retrieve UE context response message. The Xn retrieve UE context request message may include UE context information-retrieve UE context response IE including UE context information, as indicated in operation 100. FIG. 6B illustrates an example of UE context information—retrieve UE context response IE. The UE context information-retrieve UE context response IE may include a positioning information IE, as indicated in operation 200 of FIG. 6B. FIG. 6C illustrates an example of a positioning information IE. The positioning information IE may include an IE including SRS configuration information that is currently configured for the UE, such as a current SRS configuration IE, as indicated in operation 300 of FIG. 6C for the disclosure.

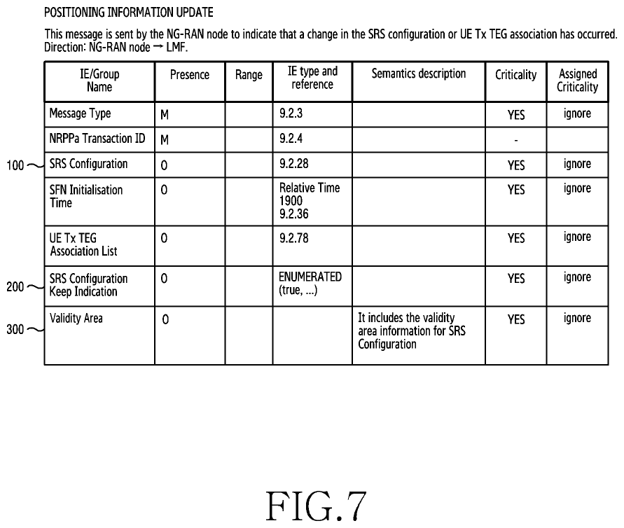

FIG. 7 illustrates an NRPPa positioning information update message and an information element (IE) included in the NRPPa positioning information update message according to an embodiment of the disclosure.

Referring to FIG. 7, an example of an NRPPa positioning information update message and an information element (IE) included in the NRPPa positioning information update message, which are transmitted by a base station to an LMF via an AMF, which are used in operation 730 of FIG. 2 and operation 600 of FIG. 3 may be described. The IE names included in FIG. 7 are illustrative only, and may be used by other names for the same function.

FIG. 7 illustrates an example of an NRPPa positioning information update message. The NRPPa positioning information update message may include UE SRS configuration information, as indicated in operation 100. In addition, for the disclosure, the NRPPa positioning information update message may include an SRS configuration keep indication IE by which information indicating that the UE SRS configuration information is kept can be transferred, as indicated in operation 200. The NRPPa positioning information update message may also include a validity area IE that includes validity area information of the SRS configuration information, as indicated in operation 300. Of course, the disclosure is not limited to the above examples, and may include only at least one of the aforementioned information.

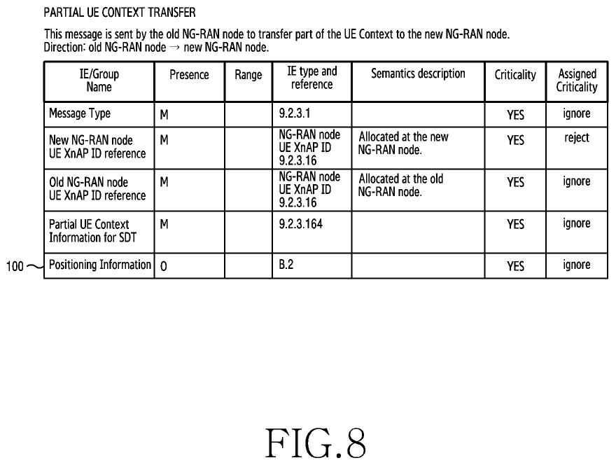

FIG. 8 illustrates an Xn partial UE context transfer message and an information element (IE) included in the Xn partial UE context transfer message according to an embodiment of the disclosure.

Referring to FIG. 8, an example of an Xn partial UE context transfer message transmitted by a last serving base station to a serving base station and an information element (IE) included in the Xn partial UE context transfer message, which are used in operation 540 of FIG. 3, may be illustrated. The IE names included in FIG. 8 are illustrative only, and may be used by other names for the same function.

FIG. 8 illustrates an example of an Xn partial UE context transfer message. The Xn partial UE context transfer message may include a positioning information IE, as indicated in operation 100 for this disclosure. The positioning information IE may correspond to an example of the IE of FIG. 6C, and may include an IE including SRS configuration information that is currently configured for the UE, for example, a current SRS configuration IE, as indicated in operation 300 of FIG. 6C. Of course, the positioning information IE is not limited to the above examples, and only at least one of the aforementioned information may be included.

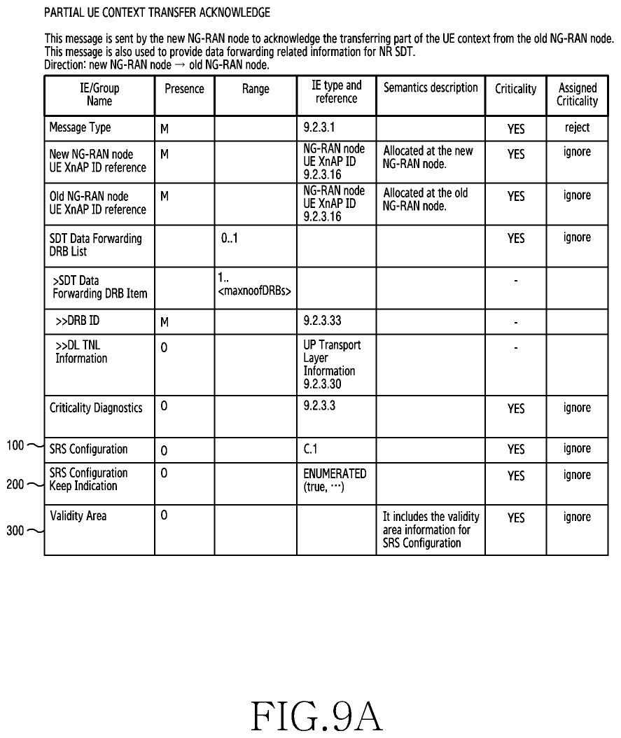

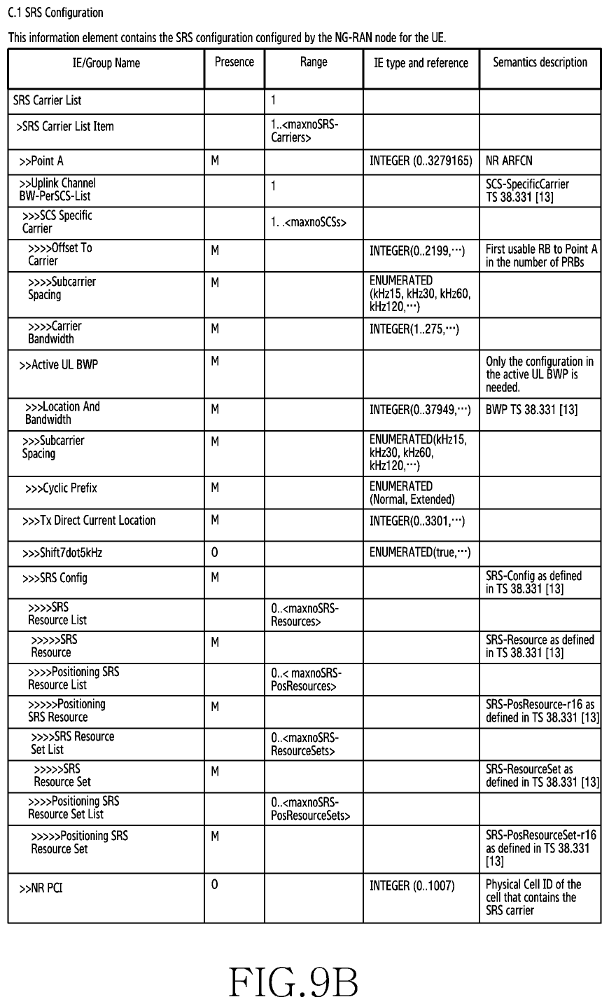

FIG. 9A illustrates an Xn partial UE context transfer acknowledge message and an information element (IE) included in the Xn partial UE context transfer acknowledge message according to an embodiment of the disclosure, and FIG. 9B illustrates an Xn partial UE context transfer acknowledge message and an information element (IE) included in the Xn partial UE context transfer acknowledge message according to an embodiment of the disclosure.

Referring now to FIGS. 9A and 9B, an example of an Xn partial UE context transfer acknowledge message transmitted by a receiving base station (or a serving base station) to a last serving base station and an information element (IE) included in the Xn partial UE context transfer acknowledge message, which are used in operation 560 of FIG. 2, may be illustrated. The IE names included in FIGS. 9A and 9B are illustrative only, and may be used by other names for the same function.

FIG. 9A illustrates an example of an Xn partial UE context transfer acknowledge message. The Xn partial UE context transfer acknowledge message may include UE SRS configuration information as indicated in operation 100, for this disclosure, an SRS configuration keep indication IE by which information indicating that the UE SRS configuration information is kept can be transferred, as indicated in operation 200, and a validity area IE that includes validity area information of the SRS configuration information, as indicated in operation 300. Of course, the Xn partial UE context transfer acknowledge message is not limited to the above examples, and may include only at least one of the aforementioned information.

FIG. 9B illustrates an example of an SRS configuration IE. The SRS configuration IE may be the same as the configuration of the SRS configuration IE used by a base station to transfer SRS configuration information to the LMF. Of course, the SRS configuration IE is not limited to the above examples.

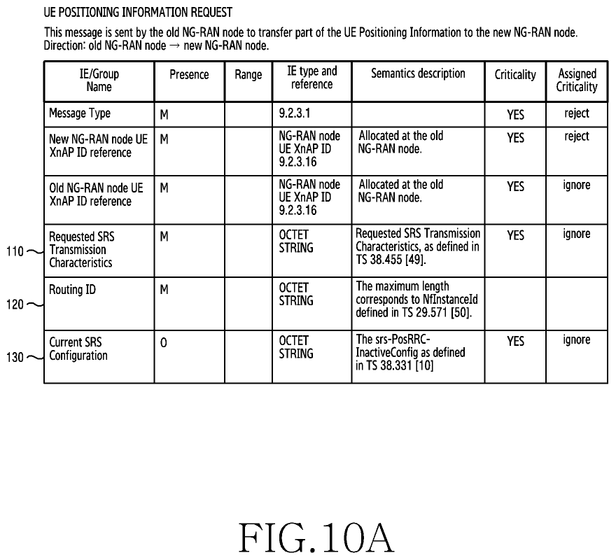

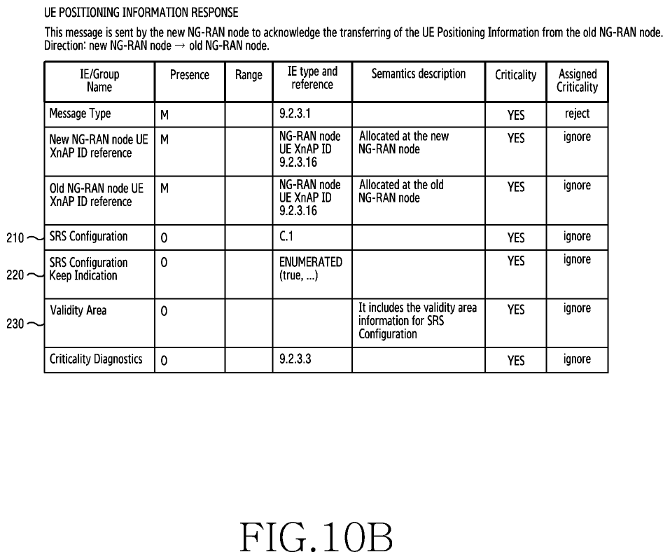

FIG. 10A illustrates an Xn UE positioning information request message, an Xn UE positioning information response message, and an information element (IE) included in the Xn UE positioning information request message and the Xn UE positioning information response message to support an Xn UE positioning information request procedure according to an embodiment of the disclosure, and FIG. 10B illustrates an Xn UE positioning information request message, an Xn UE positioning information response message, and an information element (IE) included in the Xn UE positioning information request message and the Xn UE positioning information response message to support an Xn UE positioning information request procedure according to an embodiment of the disclosure.

Referring to FIG. 10A, an example of an Xn UE positioning information request message transmitted by a last serving base station to a receiving base station (or a serving base station) and an information element (IE) included in the Xn UE positioning information request message, which are used in operation 545 of FIG. 3, may be illustrated. The message names and IE names included in FIG. 10A are illustrative only, and may be used by other names for the same function.

In FIG. 10A, the Xn UE positioning information request message may include a Message Type IE, NG-RAN node UE XnAP ID reference IE information, and the like that are included in a typical Xn message. Further, the Xn UE positioning information request message may include a requested SRS transmission characteristics IE that needs to be referenced for SRS resource configuration in the base station, as indicated in operation 110. The requested SRS transmission characteristics IE may be the same as the requested SRS transmission characteristics IE configuration including the requested SRS transmission characteristics information that the LMF transmits to the base station. The Xn UE positioning information request message may include a routing id IE that includes instance id information of the network function indicated in operation 120. The Xn UE positioning information request message may also include a current SRS configuration IE that includes the current SRS configuration information of the UE indicated in operation 130. Of course, the Xn UE positioning information request message is not limited to the above examples, and may include only at least one of the aforementioned information.

Referring to FIG. 10B, an example of an Xn UE positioning information response message transmitted by a receiving base station (or a serving base station) to a last serving base station and an information element (IE) included in the Xn UE positioning information response message, which are used in operation 565 of FIG. 3, may be illustrated. The message names and IE names included in FIG. 10B are illustrative only, and may be used by other names for the same function.

In FIG. 10B, the Xn UE positioning information response message may include Message Type IE, NG-RAN node UE XnAP ID reference IE information, and the like that are included in a typical Xn message. Further, the Xn UE positioning information response message may include an SRS configuration IE that the base station includes SRS resource configuration information, as indicated in operation 210. The configuration of the SRS configuration IE may be the same as the configuration of the SRS configuration IE of FIG. 9B. The Xn UE positioning information response message may include an SRS configuration keep indication IE by which information indicating that the UE SRS configuration information is kept can be transferred, as indicated in operation 220, and a validity area IE that includes validity area information of the SRS configuration information, as indicated in operation 230. Of course, the disclosure is not limited to the above examples, and may include only at least one of the aforementioned information.

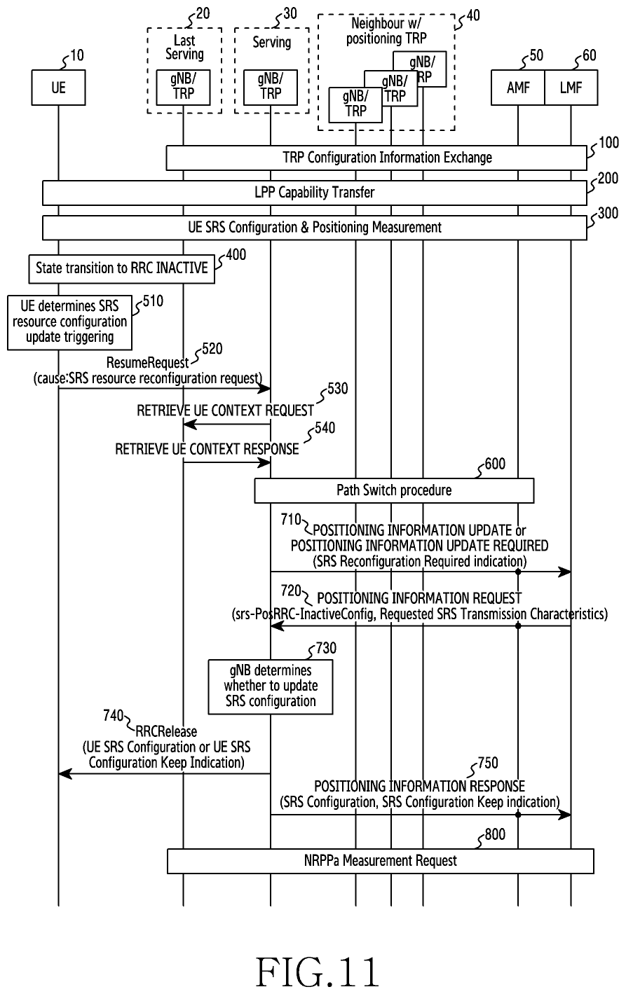

FIG. 11 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 11, the signal flow procedure from operation 100 to operation 520 in FIG. 11 corresponds to the signal flow procedure from operation 100 to operation 520 included in FIG. 2, and thus a detailed description thereof will be omitted.

Upon receiving an RRC ResumeRequest message from a UE 10, a serving base station 30 may transmit an Xn retrieve UE context request message requesting UE context information to a last serving base station 20, to which the UE 10 has been previously connected and which has stored UE context information, in operation 530. Upon receiving, from the serving base station 30, the Xn retrieve UE context request message requesting the UE context information, in operation 530, the last serving base station 20 may transmit an Xn retrieve UE context response message including the UE context information to the serving base station 30 in operation 540.

In operation 600, the serving base station 30 may perform a path switch procedure associated with cell change in the RRC INACTIVE state.

In operation 710, the serving base station 30 may transmit an NRPPa message (e.g., an NRPPa positioning information update message or a new NRPPa positioning information update required message) that includes information requesting SRS reconfiguration to the LMF 60 via the AMF 50.

Upon receiving the SRS reconfiguration request from the base station, the LMF 60 may transmit an NRPPa message (e.g., an NRPPa positioning information request message) including the requested SRS transmission characteristic information required for SRS configuration to the serving base station 30 via the AMF 50 in operation 720. The LMF may transmit the NRPPa positioning information request message by including therein the SRS configuration (srs-PosRRC-InactiveConfig) information that is currently configured for the UE.

In operation 730, the serving base station 30 may determine the SRS configuration information to be configured for the UE 10 based on the information, which has been received from the LMF 60 in operation 720. In addition, the serving base station may determine validity area information of the SRS configuration. The validity area information of the SRS configuration may include a cell list, a RAN area ID list, or a tracking area ID list.

In operation 740, the serving base station 30 may transmit, to the UE 10, an RRC message, for example an RRCRelease message, including the SRS configuration information which has been determined in operation 730. The RRC message transmitted to the UE 10 in operation 740 may include at least one of the SRS configuration information or SRS configuration keep indication of the UE. The RRC message may also include the validity area information of the SRS configuration.

In operation 750, the serving base station 30 may transmit, to the LMF 60 via the AMF 50, an NRPPa message that includes the SRS configuration information, determination of which has been made in operation 730, for example, an NRPPa positioning information response message or an NRPPa positioning information update message.

The NRPPa message transmitted to the LMF 60 in operation 750 may include at least one of SRS configuration information or SRS configuration keep indication of the UE. The NRPPa message may also include the validity area information of the SRS configuration. Among the NRPPa messages used in operation 750, the configuration of the NRPPa positioning information update message may be based on the message configuration included in FIG. 7, and in case of using the NRPPa positioning information response message, the SRS configuration keep indication IE indicated in operation 200 of FIG. 7 and the validity area IE indicated in operation 300 may be additionally included in the existing NRPPa positioning information response message.

In operation 800, the LMF 60 may determine at least one of a base station, a cell, or a TRP to monitor (measure) an uplink SRS transmitted by the UE, and may request each base station to monitor the uplink SRS of the UE by using the NRPPa measurement request procedure via the AMF 50. The LMF 60 may receive the results of measuring the uplink SRS from each base station, and may calculate the location information of the UE based on the received information.

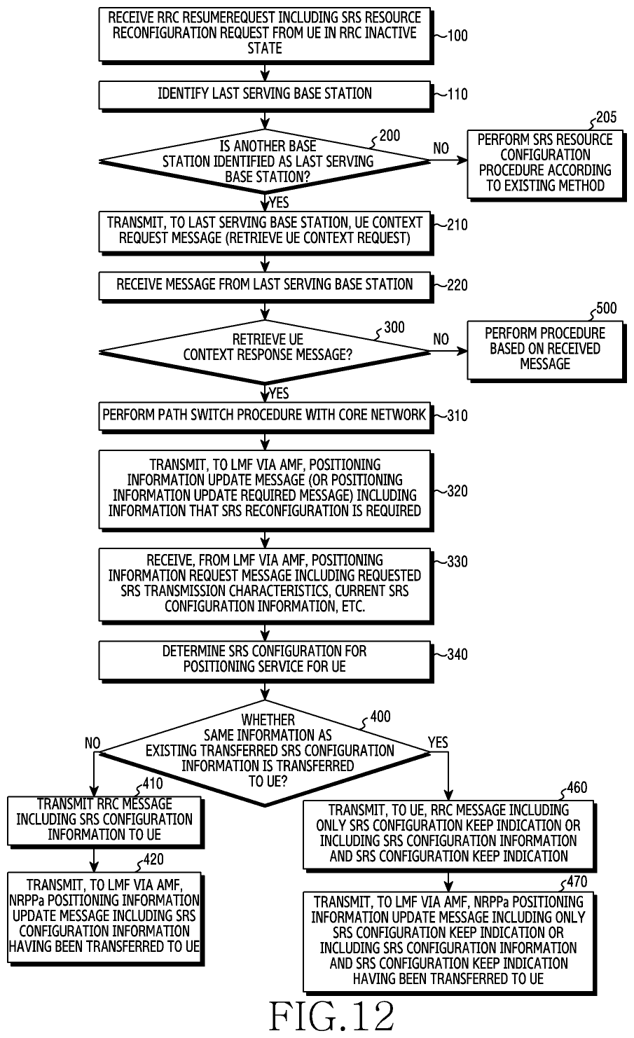

FIG. 12 illustrates an operation sequence of a base station according to an embodiment of the disclosure. With respect to the operation sequence of the base station included in FIG. 12, the base station may be unable to support some of procedures of the base station included in FIG. 12 and some operations may be omitted, depending on functions supported by the base station.

Referring to FIG. 12, in operation 100, an RRC ResumeRequest message including an SRS resource reconfiguration request is received from a UE in an RRC INACTIVE state. In operation 110, based on the RRC ResumeRequest message transmitted by the UE, identification of which base station corresponds to a last serving base station is possible. In operation 200, when the context of the UE that has transmitted the ResumeRequest message is already stored (a base station that has received the ResumeRequest message corresponds to the last serving base station), the SRS resource configuration procedure may be performed, if necessary, along with the existing RRC ResumeRequest message processing in operation 205.

As a result of the determination in operation 200, when the last serving base station is determined as another base station, a UE context request message (e.g., an Xn retrieve UE context request message) may be transmitted to the last serving base station in operation 210. In operation 220, a response message may be received from the last serving base station.

In operation 300, the type of the message, which has been received from the last serving base station in operation 220, is determined, and when the message received from the last serving base station is not a UE context response message (e.g., an Xn retrieve UE context response message), a predetermined procedure may be performed according to the type of the received message in operation 500.

As a result of the determination in operation 300, when the received message is determined as the Xn retrieve UE context response message, a path switch procedure with the core network for the corresponding UE may be performed in operation 310.

In operation 320, an NRPPa message (e.g., a positioning information update message or a positioning information update required message) including information that SRS reconfiguration is required may be transmitted to the LMF via the AMF.

In operation 330, an NRPPa message including the requested SRS transmission characteristics (e.g., an NRPPa positioning information request message) is received from the LMF via the AMF. The NRPPa positioning information request message may include, for example, current SRS configuration information.

In operation 340, the base station may determine the SRS configuration of the UE based on the UE positioning request information received from the LMF. In operation 340, the base station may also determine a validity area for the SRS configuration information of the UE.

In operation 400, the base station may determine whether the SRS configuration information of the UE, which has been determined in operation 340, is the same as the SRS configuration information currently configured for the UE. The determination performed by the base station in operation 400 may be based on a comparison with the SRS configuration information, which has been determined in operation 340, when the UE positioning-related information received from the LMF includes the current SRS configuration information of the UE.

As a result of the determination in operation 400, when SRS configuration information different from the current SRS configuration information of the UE is determined to be used, an RRC message (e.g., an RRCRelease message) including the SRS configuration information may be transmitted to the UE in operation 410. Of course, the base station may transmit the determined SRS configuration information (or a message including the SRS configuration information) without comparing whether the determined SRS configuration information is the same as the current UE SRS configuration information.

The RRC message (e.g., the RRCRelease message) transmitted to the UE in operation 410 may also include the validity area information of the SRS configuration information. In operation 420, the base station may transmit, to the LMF via the AMF, an NRPPa message (e.g., an NRPPa positioning information update message) including the SRS configuration information to be transferred to the UE. The NRPPa message transmitted in operation 420 may also include the validity area information of the SRS configuration information.

As a result of the determination in operation 400, when the same SRS configuration information as the current SRS configuration information of the UE is determined to be used, an RRC message (e.g., an RRCRelease message) including at least one of the SRS configuration information or SRS configuration keep indication may be transmitted to the UE in operation 460. The RRC message (e.g., RRCRelease message) transmitted to the UE in operation 460 may also include the validity area information of the SRS configuration information. In operation 470, the base station may transmit, to the LMF via the AMF, an NRPPa message (e.g., an NRPPa positioning information response message or an NRPPa positioning information update message) including at least one of the SRS configuration information or the SRS configuration keep indication having been transmitted to the UE. The NRPPa message transmitted in operation 470 may also include the validity area information of the SRS configuration information.

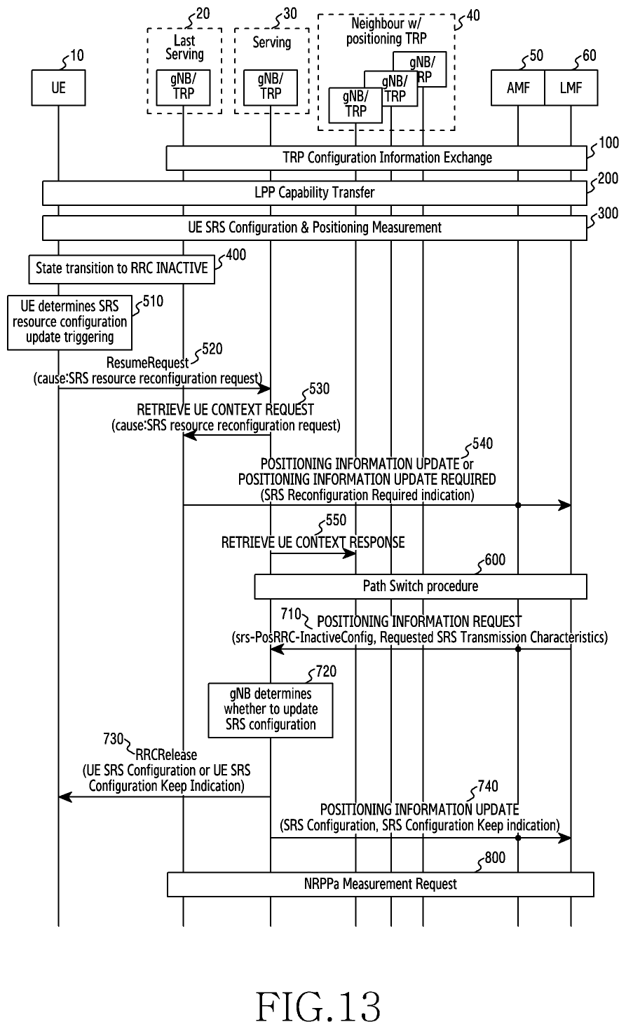

FIG. 13 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 13, the signal flow procedure from operation 100 to operation 520 in FIG. 13 corresponds to the signal flow procedure from operation 100 to operation 520 included in FIG. 2, and thus a detailed description thereof will be omitted.

Upon receiving an RRC ResumeRequest message from the UE 10, a serving base station 30 transmits an Xn retrieve UE context request message requesting UE context information to the last serving base station 20, to which the UE 10 has been previously connected and which has stored UE context information, in operation 530. The Xn retrieve UE context request message includes information indicating that the UE context is requested due to an SRS resource reconfiguration request, and the SRS reconfiguration request information may use the cause information included in the Xn retrieve UE context request message, or use separate indicator information.

Upon receiving, from the serving base station 30, the Xn retrieve UE context request message requesting the UE context by the SRS reconfiguration request, the last serving base station 20 may transmit an NRPPa message (e.g., an NRPPa positioning information update message or a new NRPPa positioning information update required message) including information requesting the SRS reconfiguration to the LMF 60 via the AMF 50 in operation 540.

In operation 550, the last serving base station 20 may transmit an Xn retrieve UE context response message including UE context information to the serving base station 30.

In operation 600, the serving base station 30 may perform a path switch procedure associated with cell change in the RRC INACTIVE state.

When the LMF 60 receives the SRS reconfiguration request from the base station in operation 540, the LMF 60 may transmit, to the serving base station 30 via the AMF 50, an NRPPa message (e.g., an NRPPa positioning information request message) that includes the requested SRS transmission characteristic information required for SRS configuration, in operation 710. The NRPPa positioning information request message may also include the SRS configuration (srs-PosRRC-InactiveConfig) information that is currently configured for the UE.

In operation 720, the serving base station 30 may determine SRS configuration information to be configured for the UE 10 based on the information, which has been received from the LMF 60 in operation 710. In addition, the serving base station 30 may determine the validity area information of the SRS configuration. The validity area information of the SRS configuration may include a cell list, a RAN area ID list, or a tracking area ID list.

In operation 730, the serving base station 30 may transmit, to the UE 10, an RRC message (e.g., an RRCRelease message) including the SRS configuration information, determination of which has been made in operation 720. The RRC message transmitted to the UE 10 in operation 730 may include at least one of the SRS configuration information or SRS configuration keep indication of the UE. In addition, the RRC message may also include the validity area information of the SRS configuration.

In operation 740, the serving base station 30 transmits, to the LMF 60 via the AMF 50, an NRPPa message, for example, an NRPPa positioning information response message or an NRPPa positioning information update message that includes the SRS configuration information, determination of which has been made in operation 720. The NRPPa message transmitted to the LMF 60 in operation 740 may include at least one of the SRS configuration information or SRS configuration keep indication of the UE. The NRPPa message may also include the validity area information of the SRS configuration. Among the NRPPa messages used in operation 740, the configuration of the NRPPa positioning information update message may be based on the message configuration included in FIG. 7, and in case of using the NRPPa positioning information response message, the SRS configuration keep indication IE indicated in operation 200 of FIG. 7 and the validity area IE indicated in operation 300 may be additionally included in the existing NRPPa positioning information response message.

In operation 800, the LMF 60 may determine at least one of a base station, a cell, or a TRP to monitor (measure) the uplink SRS transmitted by the UE, and may request each base station to monitor the uplink SRS of the UE by using the NRPPa measurement request procedure via the AMF 50. In addition, the LMF 60 may receive the results of measuring the uplink SRS from each base station, and may calculate the location information of the UE based on the received information.

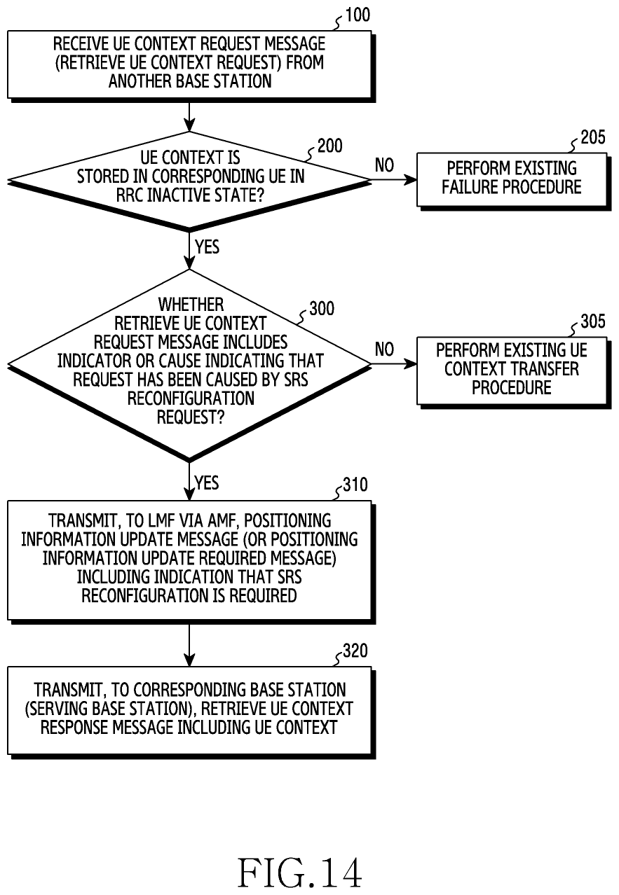

FIG. 14 illustrates an operation sequence of a base station according to an embodiment of the disclosure. With respect to the operation sequence of the base station included in FIG. 14, the base station may be unable to support some of procedures of the base station included in FIG. 14 and some operations may be omitted, depending on functions supported by the base station.

Referring to FIG. 14, in operation 100, an Xn retrieve UE context request message requesting transmission of UE context when the UE is in an RRC INACTIVE state may be received from another base station.

In operation 200, whether information of UE context, transmission of which has been requested, is stored may be determined.

As a result of the determination in operation 200, when there is no stored UE context information, an existing failure procedure may be performed in operation 205.

As a result of the determination in operation 200, when there is stored UE context information, whether the Xn retrieve UE context request message received from the other base station includes SRS reconfiguration request information may be determined in operation 300.

As a result of the determination in operation 300, when there is no SRS reconfiguration request information included in the Xn retrieve UE context request message, the existing UE context transfer procedure may be performed in operation 305.

As a result of the determination in operation 300, when there is SRS reconfiguration request information included in the Xn retrieve UE context request message, an NRPPa message (e.g., a positioning information update message or a positioning information update required message) including an indication that an SRS reconfiguration is required may be transmitted to the LMF via the AMF in operation 310.

In operation 320, an Xn retrieve UE context response message including the UE context information may be transmitted to the base station that has requested the UE context information.

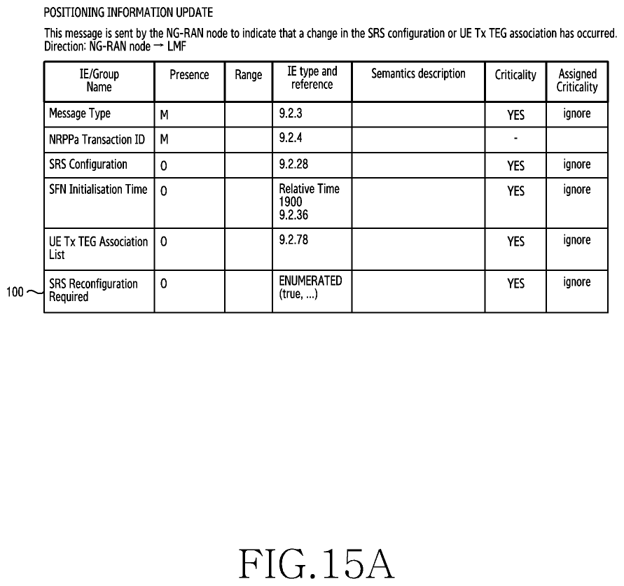

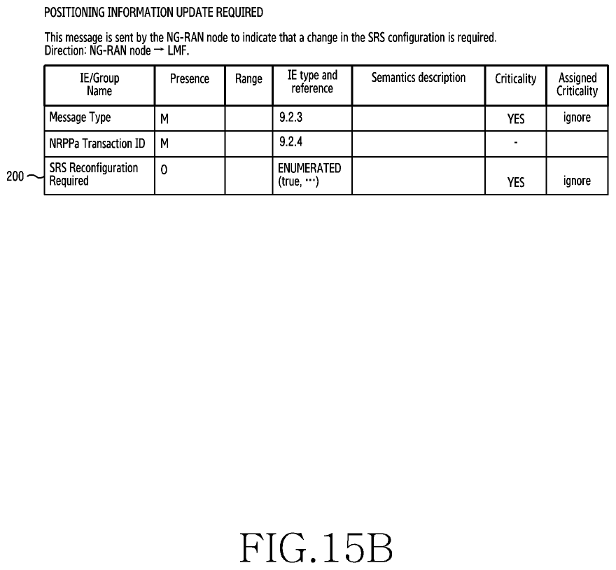

FIG. 15A illustrates an NRPPa positioning information update message, an NRPPa positioning information update required message, and an information element (IE) included in the NRPPa message according to an embodiment of the disclosure, and FIG. 15B illustrates an NRPPa positioning information update message, an NRPPa positioning information update required message, and an information element (IE) included in the NRPPa message according to an embodiment of the disclosure.

Referring to FIGS. 15A and 15B, an example of an NRPPa positioning information update message and an NRPPa positioning information update required message, which are transmitted by a base station to an LMF via an AMF, and an information element (IE) included in the NRPPa positioning information update message and the NRPPa positioning information update required message, which are used in operation 710 of FIG. 11 and operation 540 of FIG. 13 may be illustrated. The message names and IE names included in FIGS. 15A and 15B are illustrative only, and may be used by other names for the same function.

FIG. 15A illustrates an example of an NRPPa positioning information update message. The NRPPa positioning information update message may additionally include an SRS reconfiguration required IE that includes information indicating that an SRS reconfiguration of the UE is required, as indicated in operation 100.

FIG. 15B shows an example of a new NRPPa positioning information update required message.

The NRPPa positioning information update required message may include an NRPPa transaction id IE and a message type IE that is included in a general NRPPa message. Further, the NRPPa positioning information update required message may additionally include an SRS reconfiguration required IE, which includes information indicating that an SRS reconfiguration of the UE is required, as indicated in operation 200. Of course, the disclosure is not limited to the above examples and may include only at least one of the aforementioned information.

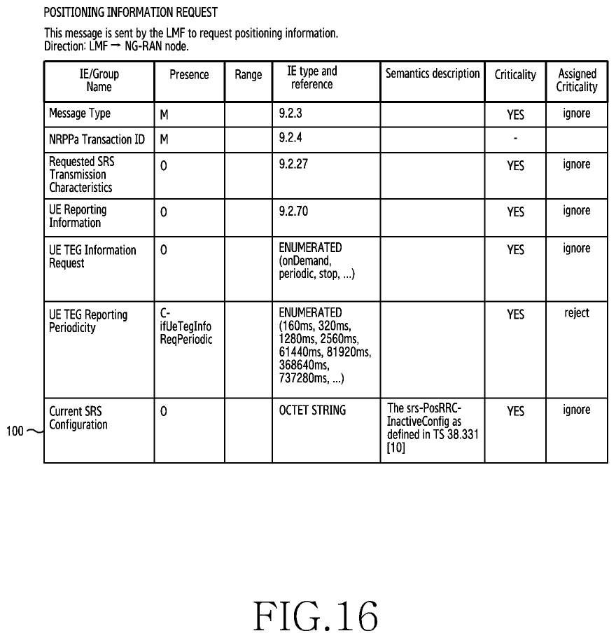

FIG. 16 illustrates an NRPPa positioning information request message and an information element (IE) included in the NRPPa positioning information request message according to an embodiment of the disclosure.

Referring to FIG. 16, an example of an NRPPa positioning information request message transmitted by an LMF to a base station via an AMF, and an information element (IE) included in the NRPPa positioning information request message, which are used in operation 720 of FIG. 16 and operation 710 of FIG. 13, may be described. The IE names included in FIG. 16 are illustrative only, and may be used by other names for the same function.

FIG. 16 illustrates an example of an NRPPa positioning information request message. The NRPPa positioning information request message may include a current SRS configuration IE that includes the current SRS configuration information of the UE, as indicated in operation 100.

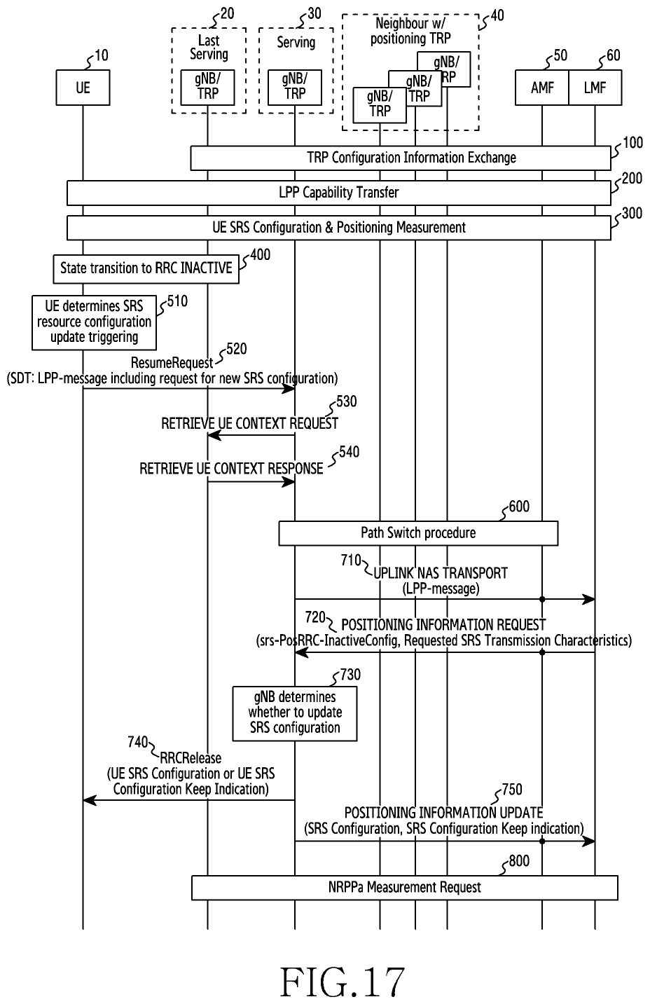

FIG. 17 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 17, the signal flow procedure from operation 100 to operation 400 in FIG. 17 corresponds to the signal flow procedure from operation 100 to operation 400 included in FIG. 2, and therefore a detailed description thereof will be omitted.

In operation 510, the UE may determine, based on system information transmitted by the serving base station, based on signals received by the base station, or based on internal operations, that the uplink SRS transmission configuration information received by the UE 10 while transitioning to the RRC INACTIVE state previously is invalid. In this case, the UE 10 may initiate a procedure to request an SRS reconfiguration. In case of the following criteria, a UE may determine that SRS reconfiguration is necessary because SRS transmission configurations are invalid.
A case in which the UE selects a cell other than a cell belonging to a validity area according to the currently stored or used SRS configuration information (Upon cell re-selection to a cell that does not belong to the validity area of the currently used SRS configuration).
A case in which the UE fails to measure a downlink reference signal (RS) for spatial information included in the SRS configuration information (Upon failure of measurement on DL RS for spatial information configured for SRS).
A case in which the UE fails to measure a downlink reference signal (RS) for pathloss information included in the SRS configuration information (Upon failure of measurement on DL RS for pathloss information configured for SRS).
A case in which the UE detects that a timing advanced (TA) value for SRS transmission becomes invalid (Upon detection of invalid TA for SRS Tx (i.e., expiry of inactivePosSRS-TimeAlignmentTimer or RSRP change over inactivePosSRS-RSRP-ChangeThreshold)).

When the UE 10 initiates the procedure for requesting the SRS reconfiguration, the UE 10 generates an LTE positioning protocol (LPP) message including information requesting the SRS reconfiguration, and in operation 520, the UE 10 transmits an RRC ResumeRequest message to the serving base station 30 (cell of the base station) currently selected by the UE 10. The RRC ResumeRequest message transmitted in operation 520 may be accompanied by an LPP message including information requesting the SRS reconfiguration, and thus the LPP message may be transferred using a small data transmission (SDT) processing method. Alternatively, the LPP message may be transmitted after the UE enters the RRC CONNECTED state. FIG. 17 illustrates an embodiment in which the LPP message is transmitted by the small data transmission (SDT) processing method.

Upon receiving the RRC ResumeRequest message from the UE 10, the serving base station 30 transmits an Xn retrieve UE context request message requesting UE context information to the last serving base station 20, to which the UE 10 has been previously connected and which has stored UE context information, in operation 530.

Upon receiving the Xn retrieve UE context request message requesting the UE context information from the serving base station 30, the last serving base station 20 may transmit, when determining to transfer the UE context to the serving base station 30, an Xn retrieve UE context response message including the UE context information to the serving base station 30, in operation 540.

In operation 600, the serving base station 30 may perform a path switch procedure associated with cell change in the RRC INACTIVE state.

In operation 710, the serving base station may transfer, to the AMF 50, an NG uplink non-access stratum (NAS) transport message including the LPP message, which has been received from the UE in operation 520, and the AMF 50 may transfer the received LPP message to the LMF 60.

When the LMF 60 receives the LPP message including the SRS reconfiguration request from the UE, the LMF 60 may transmit an NRPPa message (e.g., an NRPPa positioning information request message) including the requested SRS transmission characteristic information required for SRS configuration to the serving base station 30 via the AMF 50 in operation 720. The NRPPa positioning information request message may also include the SRS configuration (srs-PosRRC-InactiveConfig) information that is currently configured for the UE. The configuration of the NRPPa positioning information request message used in operation 720 may correspond to the configuration described in FIG. 16.

In operation 730, the serving base station 30 may determine SRS configuration information to be configured for the UE 10 based on the information, which has been received from the LMF 60 in operation 720. In addition, the serving base station 30 may determine validity area information of the SRS configuration. The validity area information of the SRS configuration may include a cell list, a RAN area ID list, or a tracking area ID list.

In operation 740, the serving base station 30 may transmit an RRC message including the SRS configuration information, determination of which has been made in operation 730, for example, an RRCRelease message, to the UE 10. The RRC message transmitted to the UE 10 in operation 740 may include at least one of the SRS configuration information or SRS configuration keep indication of the UE. The RRC message may also include the validity area information of the SRS configuration.

In operation 750, the serving base station 30 transmits an NRPPa message that includes the SRS configuration information, determination of which has been made in operation 730, for example, an NRPPa positioning information response message or an NRPPa positioning information update message, to the LMF 60 via the AMF 50. The NRPPa message transmitted to the LMF 60 in operation 750 may include at least one of the SRS configuration information or SRS configuration keep indication of the UE. The NRPPa message may also include the validity area information of the SRS configuration. Among the NRPPa messages used in operation 750, the configuration of the NRPPa positioning information update message may correspond to the message configuration included in FIG. 7, and in case of using the NRPPa positioning information response message, the SRS configuration keep indication IE indicated in operation 200 of FIG. 7 and the validity area IE indicated in operation 300 may be additionally included in the existing NRPPa positioning information response message. Of course, the message configuration is not limited to the above examples.

In operation 800, the LMF 60 may determine at least one of a base station, a cell, or a TRP to monitor (measure) the uplink SRS transmitted by the UE, and may request each base station to monitor the uplink SRS of the UE by using the NRPPa measurement request procedure via the AMF 50. The LMF 60 may receive the results of measuring the uplink SRS from each base station, and may calculate the location information of the UE based on the received information.

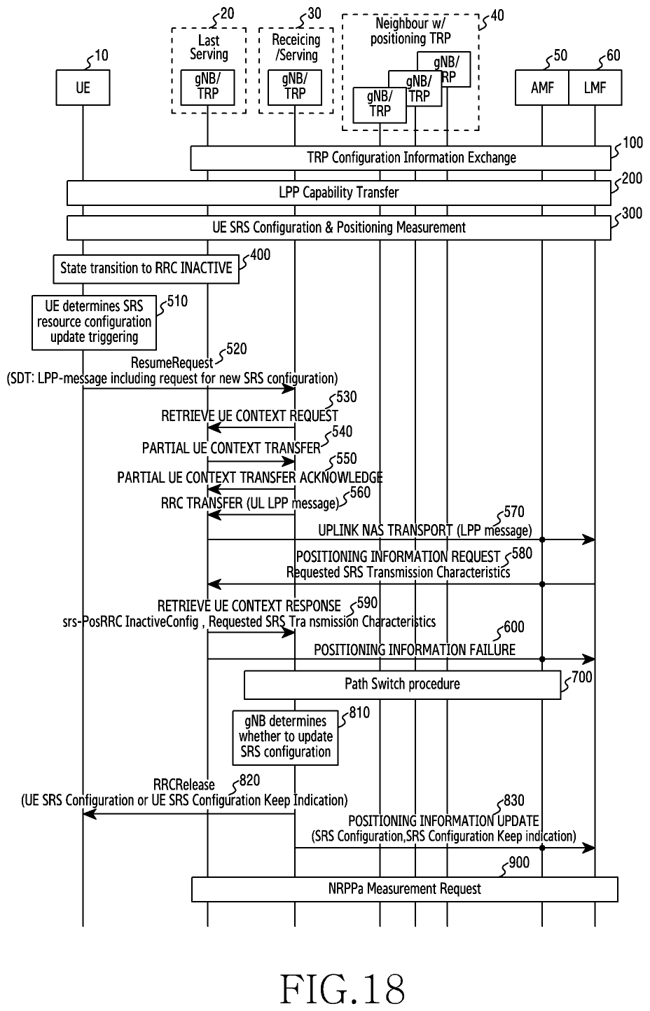

FIG. 18 is a signal flow illustrating reconfiguration of uplink sounding reference signal (SRS) configuration information transmitted by a UE for positioning service while the UE is in an RRC INACTIVE state according to an embodiment of the disclosure.

Referring to FIG. 18, the signal flow procedure from operation 100 to operation 400 in FIG. 18 corresponds to the signal flow procedure from operation 100 to operation 400 included in FIG. 2, and therefore a detailed description thereof is omitted.

In operation 510, the UE may determine, based on system information transmitted by the serving base station, based on signals received by the base station, or based on internal operations, that the uplink SRS transmission configuration information received by the UE 10 while transitioning to the RRC INACTIVE state previously is invalid. In this case, the UE 10 may initiate a procedure to request an SRS reconfiguration. In case of the following criteria, a UE may determine that SRS reconfiguration is necessary because SRS transmission configurations are invalid.
A case in which the UE selects a cell other than a cell belonging to a validity area according to the currently stored or used SRS configuration information (Upon cell re-selection to a cell that does not belong to the validity area of the currently used SRS configuration).
A case in which the UE fails to measure a downlink reference signal (RS) for spatial information included in the SRS configuration information (Upon failure of measurement on DL RS for spatial information configured for SRS).
A case in which the UE fails to measure a downlink reference signal (RS) for pathloss information included in the SRS configuration information (Upon failure of measurement on DL RS for pathloss information configured for SRS).
A case in which the UE detects that a timing advanced (TA) value for SRS transmission becomes invalid (Upon detection of invalid TA for SRS Tx (i.e., expiry of inactivePosSRS-TimeAlignmentTimer or RSRP change over inactivePosSRS-RSRP-ChangeThreshold)).

When the UE 10 initiates the procedure for requesting the SRS reconfiguration, the UE 10 generates an LTE positioning protocol (LPP) message including information requesting the SRS reconfiguration, and in operation 520, the UE 10 transmits an RRC ResumeRequest message to a serving base station 30 (cell of the base station) currently selected by the UE 10. The RRC ResumeRequest message transmitted in operation 520 may be accompanied by an LPP message including information requesting the SRS reconfiguration, and thus the LPP message may be transferred using a small data transmission (SDT) processing method. Alternatively, the LPP message may be transmitted after the UE enters the RRC CONNECTED state. FIG. 18 illustrates an embodiment in which the LPP message is transmitted by the small data transmission (SDT) processing method.

Upon receiving the RRC ResumeRequest message from the UE 10, the receiving/serving base station 30 transmits an Xn retrieve UE context request message requesting UE context information to the last serving base station 20, to which the UE 10 has been previously connected and which has stored UE context information, in operation 530. Upon receiving the Xn retrieve UE context request message requesting the UE context information from the receiving/serving base station 30, the last serving base station 20 may transmit, when determining to continue storing the UE context information without transferring the same to the receiving/serving base station 30, an Xn partial UE context transfer message including a part of the UE context information to the receiving/serving base station 30 in operation 540.

In operation 550, the receiving/serving base station 30 may respond to the last serving base station 20 with an Xn partial UE context transfer acknowledge message.

In operation 560, the receiving/serving base station 30 may transmit, to the serving base station 20, an Xn RRC transfer message including the LPP message transmitted by the UE.

In operation 570, the last serving base station 20 may transmit an NG uplink NAS transport message including the LPP message, which has been received from the receiving/serving base station 30 in operation 560, to the AMF 50, and the AMF 50 may transfer the received LPP message to the LMF 60.

When the LMF 60 receives the LPP message including the SRS reconfiguration request from the UE, the LMF 60 may transmit an NRPPa message (e.g., an NRPPa positioning information request message) including the requested SRS transmission characteristic information required for SRS configuration to the last serving base station 30 via the AMF 50 in operation 580.

Upon receiving the NRPPa positioning information request message including the requested SRS transmission characteristic information required for SRS configuration from the LMF 60, the last serving base station 20 may transmit an Xn retrieve UE context response message including the UE context to the receiving/serving base station 30 in operation 590. The Xn retrieve UE context response message may include the requested SRS transmission characteristic information required for SRS configuration. In operation 590, the last serving base station 20 may also include, in the Xn retrieve UE context response message, the SRS configuration (srs-PosRRC-InactiveConfig) information that is currently configured for the UE and transmit the same. The configuration of the Xn retrieve UE context response message used in operation 590 may correspond to that described in FIG. 6A.

In operation 600, the last serving base station 20 may transmit an NRPPa positioning information failure message to the LMF 60 via the AMF 50. The NRPPa positioning information failure message may include information indicating that a failure has occurred due to movement of the UE to another cell.

In operation 700, the serving base station 30 may perform a path switch procedure associated with cell change in the RRC INACTIVE state.

In operation 810, the serving base station 30 may determine SRS configuration information to be configured for the UE 10 based on the positioning-related information, which has been received from the last serving base station 20 in operation 590. In addition, the serving base station 30 may determine validity area information of the SRS configuration. The validity area information of the SRS configuration may include a cell list, a RAN area ID list, or a tracking area ID list.

In operation 820, the serving base station 30 may transmit, to the UE 10, an RRC message including the SRS configuration information, determination of which has been made in operation 810, for example, an RRCRelease message. The RRC message, which has been transmitted to the UE 10 in operation 820, may include at least one of the SRS configuration information or SRS configuration keep indication of the UE. The RRC message may also include the validity area information of the SRS configuration.

In operation 830, the serving base station 30 may transmit, to the LMF 60 via the AMF 50, an NRPPa message that includes the SRS configuration information, determination of which has been made in operation 810, for example an NRPPa positioning information update message. The NRPPa message, which has been transmitted to the LMF 60 in operation 730, may include at least one of SRS configuration information or SRS configuration keep indication of the UE. The NRPPa message may also include validity area information of the SRS configuration.

In operation 900, the LMF 60 may determine at least one of a base station, a cell, or a TRP to monitor (measure) the uplink SRS transmitted by the UE, and may request each base station to monitor the uplink SRS of the UE by using the NRPPa measurement request procedure via the AMF 50. The LMF 60 may receive the results of measuring the uplink SRS from each base station, and may calculate the location information of the UE based on the received information.

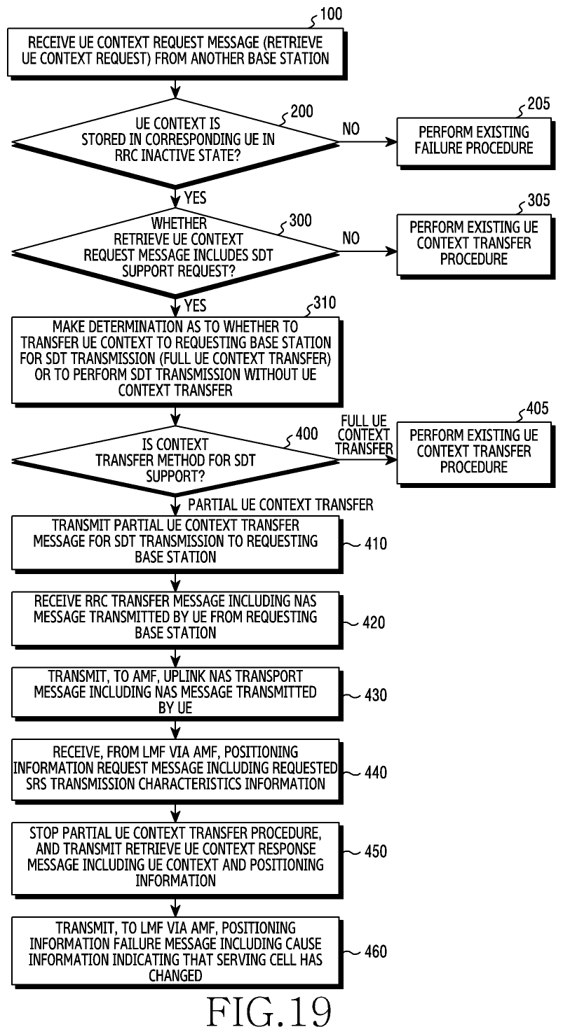

FIG. 19 illustrates an operation sequence of a base station according to an embodiment of the disclosure. With respect to the operation sequence of the base station, included in FIG. 19, the base station may be unable to support some of procedures of the base station included in FIG. 19 and some operations may be omitted, depending on functions supported by the base station.

Referring to FIG. 19, in operation 100, an Xn retrieve UE context request message requesting transmission of a UE context when the UE is in an RRC INACTIVE state may be received from another base station.

In operation 200, whether information of UE context, transmission of which has been requested, is stored may be determined.

As a result of the determination in operation 200, when there is no stored UE context information, an existing failure procedure may be performed in operation 205.

As a result of the determination in operation 200, when there is stored UE context information, whether the Xn retrieve UE context request message received from the other base station includes SDT support request information may be determined in operation 300.

As a result of the determination in operation 300, when there is no SDT support request information included in the Xn retrieve UE context request message, the existing UE context transfer procedure may be performed in operation 305.

As a result of the determination in operation 300, when the SDT support request information is included in the Xn retrieve UE context request message, whether to transfer the UE context to a requesting base station for SDT transmission of the UE or to continue storing the UE context may be determined in operation 310.

As a result of the determination in operation 310, when the UE context is determined to be transferred in operation 400, the existing UE context transfer procedure may be performed in operation 405.

As a result of the determination in operation 310, when a partial UE context transfer procedure is determined to be used rather than transferring the UE context in operation 400, an Xn partial UE context transfer message to support SDT transmission may be transmitted to the requesting base station in operation 410.

In operation 420, an NAS message transmitted by the UE (the NAS message may include an LPP message transmitted by the UE) may be received from the requesting base station.

In operation 430, the NAS message transmitted by the UE may be transferred to the AMF by using an NG uplink NAS transport message.

In operation 440, an NRPPa positioning information request message including a positioning information request may be received from the LMF via the AMF. The positioning information request may include requested SRS transmission characteristics information.

In operation 450, the partial UE context transfer procedure may be stopped and an Xn retrieve UE context response message including UE context information may be transmitted to the requesting base station. The Xn retrieve UE context response message may include positioning information, and the request for positioning information may include requested SRS transmission characteristics information. In addition, the positioning information may include current SRS configuration information of the UE.

In operation 460, an NRPPa positioning information failure message including information indicating that the NRPPa positioning information procedure has failed due to a change in the serving cell may be transmitted to the LMF via the AMF.

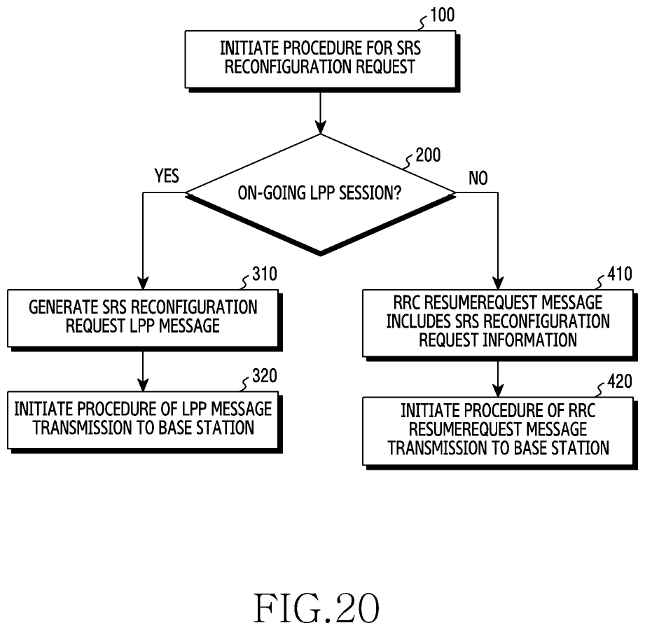

FIG. 20 illustrates an operation sequence of a UE according to an embodiment of the disclosure. With respect to the operation sequence of the UE included in FIG. 20, the UE may be unable to support some of procedures of the UE included in FIG. 20 and some operations may be omitted, depending on functions supported by the UE.

Referring to FIG. 20, in operation 100, an SRS reconfiguration for positioning service is required when the UE is in an RRC INACTIVE state is determined, and a procedure associated therewith may be initiated. In case of the following criteria, a UE may determine that SRS reconfiguration is necessary because SRS transmission configurations are invalid.
A case in which the UE selects a cell other than a cell belonging to a validity area according to the currently stored or used SRS configuration information (Upon cell re-selection to a cell that does not belong to the validity area of the currently used SRS configuration).
A case in which the UE fails to measure a downlink reference signal (RS) for spatial information included in the SRS configuration information (Upon failure of measurement on DL RS for spatial information configured for SRS).
A case in which the UE fails to measure a downlink reference signal (RS) for pathloss information included in the SRS configuration information (Upon failure of measurement on DL RS for pathloss information configured for SRS).
A case in which the UE detects that a timing advanced (TA) value for SRS transmission becomes invalid (Upon detection of invalid TA for SRS Tx (i.e., expiry of inactivePosSRS-TimeAlignmentTimer or RSRP change over inactivePosSRS-RSRP-Change Threshold)).

In operation 200, a determination may be made as to whether there is a currently connected LTE positioning protocol (LPP) session.

When there is a currently connected LTE positioning protocol (LPP) session in operation 200, an LPP message including the SRS reconfiguration request information may be generated in operation 310, and a procedure for transmitting the LPP message to the base station may be initiated in operation 320.

When there is no currently connected LTE positioning protocol (LPP) session in operation 200, an RRC ResumeRequest message including the SRS reconfiguration request information may be generated in operation 310, and the procedure for transmitting the RRC ResumeRequest message to the base station may be initiated in operation 320.

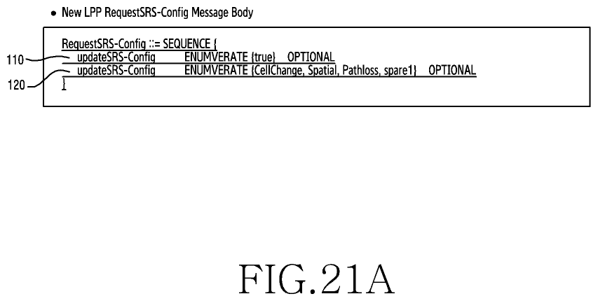

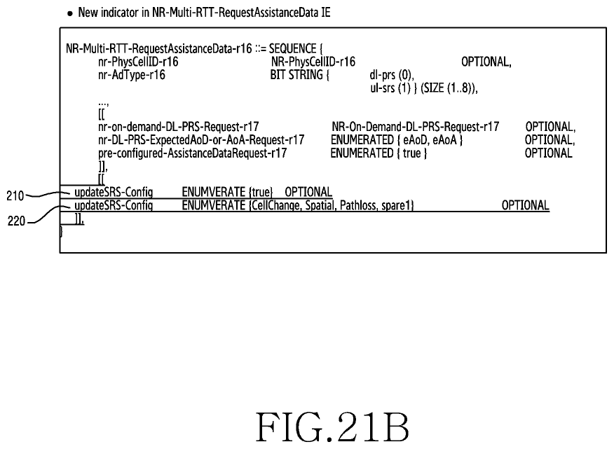

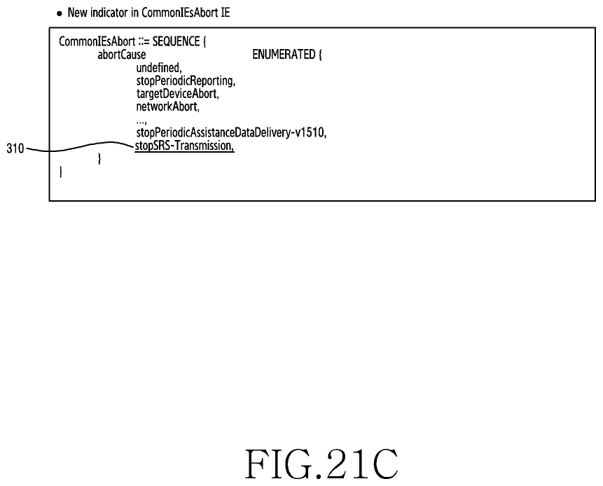

FIG. 21A illustrates an LTE positioning protocol (LPP) message and a configuration of an information element (IE) included in the LPP message according to an embodiment of the disclosure, FIG. 21B illustrates an LTE positioning protocol (LPP) message and a configuration of an information element (IE) included in the LPP message according to an embodiment of the disclosure, and FIG. 21C illustrates an LTE positioning protocol (LPP) message and a configuration of an information element (IE) included in the LPP message according to an embodiment of the disclosure.

Referring to FIGS. 21A, 21B, and 21C, an example of an LPP message that a UE transmits to an LMF to request an SRS reconfiguration and an information element (IE) included in the LPP message, which are used in operation 520 of FIG. 17 and operation 520 of FIG. 18, may be described. The IE names included in FIGS. 21A to 21C are illustrative only, and may be used by other names for the same function.

FIG. 21A illustrates an example of a new LPP RequestSRS-Config message used by a UE to request an SRS reconfiguration from an LMF. The new LPP RequestSRS-Config message may be configured to include a RequestSRS-Config message added with an updateSRS-Config, as indicated in operation 110, and to allow the updateSRS-Config to include only ‘true’ information. Further, in another method, the RequestSRS-Config message may be added with an updateSRS-Config IE as indicated in operation 120, and the updateSRS-Config IE may include information about a cause for the SRS reconfiguration request. The cause for the SRS reconfiguration request included in the updateSRS-Config IE may include one of the following information of cell change (‘CellChange’), downlink reference signal (RS) measurement failure for spatial information (‘Spatial’), and downlink reference signal (RS) measurement failure for pathloss information (‘Pathloss’).

FIG. 21B shows an example of an NR-Multi-RTT-RequestAssistanceData IE obtained by adding information, which is used for requesting SRS reconfiguration from an LMF, to an NR-Multi-RTT-RequestAssistanceData IE included in an existing message transmitted by the UE to the LMF. The example of the NR-Multi-RTT-RequestAssistanceData IE may be configured to include an NR-Multi-RTT-RequestAssistanceData IE added with an updateSRS-Config IE, as indicated in operation 210, and to allow the updateSRS-Config IE to include only ‘true’ information. Further, in another method, the NR-Multi-RTT-RequestAssistanceData IE may be added with an updateSRS-Config IE as indicated in operation 220, and the updateSRS-Config IE may include information about a cause for the SRS reconfiguration request. The cause for the SRS reconfiguration request included in the updateSRS-Config IE may include one of the following information of cell change (‘CellChange’), downlink reference signal (RS) measurement failure for spatial information (‘Spatial’), and downlink reference signal (RS) measurement failure for pathloss information (‘Pathloss’).

FIG. 21C shows an example of a CommonIEsAbort IE obtained by adding information, which is used for requesting an SRS reconfiguration from the LMF, to a CommonIEsAbort IE included in an existing message transmitted by a UE to the LMF. For the disclosure, stopSRS-Transmission may be added to an abortCause included in the CommonIEsAbort IE, as indicated in operation 310. When the UE configures the abortCause as stopSRS-Transmission, the UE transfers information indicating stop of SRS transmission for positioning service to the LMF and thus allows the LMF to initiate a procedure for SRS reconfiguration.

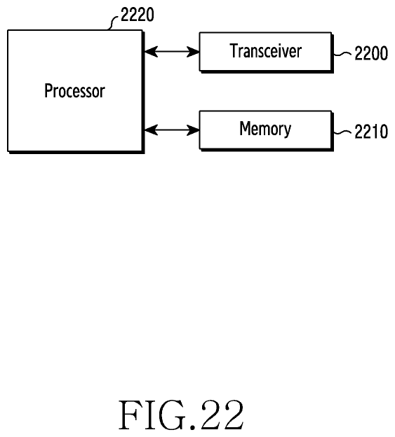

FIG. 22 illustrates the structure of a base station according to an embodiment of the disclosure.

Referring to FIG. 22, the base station of the disclosure may include a processor 2220, a transceiver 2200, and memory 2210. However, the elements of the base station are not limited to the above examples. For example, the base station may include more or fewer elements than those described above. In addition, the processor 2220, the transceiver 2200, and the memory 2210 may be implemented in the form of a single chip. Additionally, one base station may be separately organized into a plurality of network devices, such as a central unit (CU), a distributed unit (DU), and a remote unit (RU).

According to an embodiment of the disclosure, the processor 2220 may control a series of processes by which the base station may operate according to the above-described embodiment of the disclosure. For example, the processor 2220 may control the elements of the base station to perform the SRS reconfiguration method to support a positioning service for a terminal according to the above-described embodiments. The processor 2220 may control the elements of the base station to perform the above-described embodiments of the disclosure by executing a program stored in the memory 2210. Additionally, the processor 2220 may be an application processor (AP), a communication processor (CP), a circuit, an application-specific circuit, or at least one processor.

According to an embodiment of the disclosure, the transceiver 2200 may transmit and receive signals to or from a network entity, another base station, or a terminal. Signals transmitted and received to or from the network entity, anther base station, or terminal may include control information and data. The transceiver 2200 may include a radio frequency (RF) transmitter that up-converts and amplifies the frequency of a transmitted signal, and an RF receiver that performs low-noise amplification of a received signal and down-converts the frequency. However, this is only an example of the transceiver 2200, and the elements of the transceiver 2200 are not limited to the RF transmitter and RF receiver. Additionally, the transceiver 2200 may receive a signal through a wireless channel and output the received signal to the processor 2220, and may transmit the signal output from the processor 2220 through a wireless channel.

According to an embodiment of the disclosure, the memory 2210 may store programs and data necessary for the operation of the base station. Additionally, the memory 2210 may store control information or data included in signals transmitted and received by the base station. The memory 2210 may include a storage medium such as a read only memory (ROM), a random access memory (RAM), a hard disk, a compact disc read only memory (CD-ROM), and a digital versatile disc (DVD), or a combination of storage media. Additionally, there may be multiple memories 2210. Additionally, according to an embodiment, the memory 2210 may store a program for performing an SRS reconfiguration method to support the positioning service for the terminal.

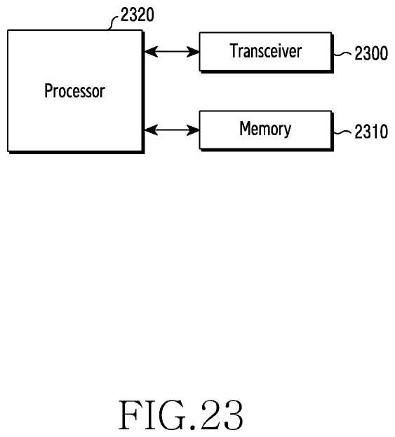

FIG. 23 illustrates the structure of a terminal according to an embodiment of the disclosure.

Referring to FIG. 23, the terminal of the disclosure may include a processor 2320, a transceiver 2300, and memory 2310. However, the elements of the terminal are not limited to the above examples. For example, the terminal may include more or fewer elements than those described above. In addition, the processor 2320, the transceiver 2300, and the memory 2310 may be implemented in the form of a single chip. Additionally, the processor 2320, the transceiver 2300, and the memory 2310 may be implemented as a single chip.

According to an embodiment of the disclosure, the processor 2320 may control a series of processes by which the terminal may operate according to the above-described embodiment of the disclosure. For example, the processor 2320 may control the elements of the terminal to perform the SRS reconfiguration method to support the positioning service for the terminal according to the above-described embodiments. The processor 2320 may control the elements of the terminal to perform the above-described embodiments of the disclosure by executing a program stored in the memory 2310. Additionally, the processor 2320 may be an application processor (AP), a communication processor (CP), a circuit, an application-specific circuit, or at least one processor.

According to an embodiment of the disclosure, the transceiver 2300 may transmit and receive signals to or from a network entity, another terminal, or a base station. Signals transmitted and received to or from the network entity, anther terminal, or base station may include control information and data. The transceiver 2300 may include an RF transmitter that up-converts and amplifies the frequency of a transmitted signal, and an RF receiver that performs low-noise amplification of a received signal and down-converts the frequency. However, this is only an example of the transceiver 2300, and the elements of the transceiver 2300 are not limited to the RF transmitter and RF receiver. Additionally, the transceiver 2300 may receive a signal through a wireless channel and output the received signal to the processor 2320, and may transmit the signal output from the processor 2320 through a wireless channel.

According to an embodiment of the disclosure, the memory 2310 may store programs and data necessary for the operation of the terminal. Additionally, the memory 2310 may store control information or data included in signals transmitted and received by the terminal. The memory 2310 may include a storage medium such as a ROM, a RAM, a hard disk, a CD-ROM, and a DVD, or a combination of storage media. Additionally, there may be multiple memories 2310. Additionally, according to an embodiment, the memory 2310 may store a program for performing an SRS reconfiguration method to support the positioning service for the terminal described above.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first base station (BS) in a wireless communication system, the method comprising:
transmitting, to a second base station (BS), a retrieve user equipment (UE) context request message for sounding reference signal (SRS) configuration; and
receiving requested sounding reference signal (SRS) transmission characteristics for the SRS configuration.

2. The method of claim 1,
wherein the requested SRS transmission characteristics are received from the second BS through a partial UE context transfer message, and
wherein the partial UE context transfer message includes a partial UE context information for positioning comprising the requested SRS transmission characteristics.

3. The method of claim 2, the method further comprising:
transmitting, to the second BS, a partial UE context transfer acknowledge message including the SRS configuration.

4. The method of claim 1, wherein the requested SRS transmission characteristics are received from a location management function (LMF).

5. The method of claim 2, wherein the partial UE context information for positioning further includes at least one of a routing identifier (ID), new radio (NR) positioning protocol A (NRPPa) transaction id or current SRS configuration.

6. A method performed by a second base station (BS) in a wireless communication system, the method comprising:
receiving, from a first base station (BS), a retrieve user equipment (UE) context request message for sounding reference signal (SRS) configuration; and
transmitting information for the SRS configuration.

7. The method of claim 6,
wherein the information for the SRS configuration is transmitted to the first BS through a partial UE context transfer message,
wherein the information for the SRS configuration includes requested SRS transmission characteristics, and
wherein the partial UE context transfer message includes a partial UE context information for positioning comprising the requested SRS transmission characteristics.

8. The method of claim 7, the method further comprising:
receiving, from the first BS, a partial UE context transfer acknowledge message including the SRS configuration.

9. The method of claim 6, wherein the information for the SRS configuration is transmitted to a location management function (LMF) via an access and mobility management function (AMF).

10. The method of claim 9, wherein the information for the SRS configuration includes an indication for the SRS configuration.

11. A first base station (BS) in a wireless communication system, the first BS comprising:
a transceiver; and
a processor coupled with the transceiver and configured to:
transmit, to a second base station (BS), a retrieve user equipment (UE) context request message for sounding reference signal (SRS) configuration, and
receive requested sounding reference signal (SRS) transmission characteristics for the SRS configuration.

12. The first BS of claim 11,
wherein the requested SRS transmission characteristics are received from the second BS through a partial UE context transfer message, and
wherein the partial UE context transfer message includes a partial UE context information for positioning comprising the requested SRS transmission characteristics.

13. The first BS of claim 12, the processor further configured to:
transmit, to the second BS, a partial UE context transfer acknowledge message including the SRS configuration.

14. The first BS of claim 11, wherein the requested SRS transmission characteristics are received from a location management function (LMF).

15. The first BS of claim 12, wherein the partial UE context information for positioning further includes at least one of a routing identifier (ID), new radio (NR) positioning protocol A (NRPPa) transaction id or current SRS configuration.

16. A second base station (BS) in a wireless communication system, the second BS comprising:
a transceiver; and
a processor coupled with the transceiver and configured to:
receive, from a first base station (BS), a retrieve user equipment (UE) context request message for sounding reference signal (SRS) configuration, and
transmit information for the SRS configuration.

17. The second BS of claim 16,
wherein the information for the SRS configuration is transmitted to the first BS through a partial UE context transfer message,
wherein the information for the SRS configuration includes requested SRS transmission characteristics, and
wherein the partial UE context transfer message includes a partial UE context information for positioning comprising the requested SRS transmission characteristics.

18. The second BS of claim 17, the processor further configured to:
receive, from the first BS, a partial UE context transfer acknowledge message including the SRS configuration.

19. The second BS of claim 16, wherein the information for the SRS configuration is transmitted to a location management function (LMF) via an access and mobility management function (AMF).

20. The second BS of claim 19, wherein the information for the SRS configuration includes an indication for the SRS configuration.
